(19) United States
(12) Patent Application Publication
(10) Pub. No.: US 2025/0313502 A1
(43) Pub. Date: Oct. 9, 2025

(54) SINTER-FREE LOW-TEMPERATURE 3D-PRINTING OF NANOSCALE OPTICAL GRADE FUSED SILICA GLASS

(71) Applicant: THE REGENTS OF THE UNIVERSITY OF CALIFORNIA, Oakland, CA (US)

(72) Inventors: Jens BAUER, Oakland, CA (US); Cameron CROOK, Oakland, CA (US); Tommaso BALDACCHINI, Irvine, CA (US)

(73) Assignee: THE REGENTS OF THE UNIVERSITY OF CALIFORNIA, Oakland, CA (US)

(21) Appl. No.: 18/863,488

(22) PCT Filed: May 8, 2023
(86) PCT No.: PCT/US2023/021379

§ 371 Date: Nov. 6, 2024

Related U.S. Application Data
(60) Provisional application No. 63/339,241, filed on May 6, 2022.

(51) Int. Cl. C03B 20/00; B33Y 10/00; B33Y 40/20; B33Y 70/00; C03C 3/06; C08F 283/12; C09D 4/00; C09D 151/08; G02B 1/00

(52) U.S. Cl. CPC C03B 20/00; B33Y 10/00; B33Y 40/20; B33Y 70/00; C03C 3/06; C08F 283/124; C09D 4/00; C09D 151/085; C03C 2201/02; C03C 2203/20; G02B 1/00

(57) ABSTRACT

A method for fabricating glass structures on a substrate includes a step of contacting the substrate with a liquid reactive composition that includes a silsesquioxane, an acrylic oligomer or monomer, and a photoinitiator. The silsesquioxane and the acrylic oligomer or monomer are each independently functionalized with at least two acrylate groups. Light is directed to the substrate such that the reactive composition forms polymeric coating on the substrate. The polymeric coating is heat treated in an oxygen-containing gas environment at a sufficiently high temperature to convert the partially cured coating to a glass, the sufficiently high temperature being lower than the melting point of the substrate.

### CROSS-REFERENCE TO RELATED APPLICATIONS

This application claims the benefit of U.S. patent application Ser. No. 63/339,241 filed May 6, 2022, the disclosure of which is hereby incorporated in its entirety by reference herein.

### TECHNICAL FIELD

In at least one aspect, the present invention is related to the printing of glass structures suitable for photonics applications.

### BACKGROUND

At present, the 3D free-form manufacturing of silica glass is dominated by techniques relying on particle-loaded binders and sintering (1-4). However, those impose several limitations holding back their adoption within microsystem technology, preventing major technological breakthroughs.

Silica glass has a softening point of 1100° C., making it historically challenging to structure. However, its superior optical transparency, thermal-, chemical-, and mechanical resilience make it one of the most important materials for modern engineering applications, including micro-optics (5, 6), photonics (7-9), microelectromechanical systems (MEMS) (10, 11), micro-fluidics and biomedicine (12, 13). Established microsystems synthesis routes (14) manufacture silica structures via elaborate top-down process sequences, involving techniques like 2D mask lithography, thermal oxidation, vapor deposition, and etching, but these processes hardly translate to 3D designs. Recently, the free-form manufacturing of silica glass has greatly advanced. However, the most advanced 3D-printing and molding methods (12) still rely on melting or particle-sintering steps identical to ancient blowing techniques and established industrial processes.

Nearly unconstrained 3D design freedom at nanometer resolution grants two-photon polymerization (TPP) 3D-printing (15) the potential to radically transform microsystem technology, which today is largely constrained to planar structures. However, TPP-printing is based on the laser exposure of photosensitive materials, which are most commonly polymers with intrinsically variable optical (16) and mechanical properties (17) and limited environmental stability. TPP facilitates the in situ 3D-printing of complexly shaped polymeric free-form micro- and nanostructures (18-20), directly on microchips. If the same could be achieved with robust silica glass instead of polymer, the technique could realize major breakthroughs within opto-electrical systems, like superior imaging devices (18, 21), optical MEMS (10, 11), and nanophotonic integrated circuits (19, 20), such as for the development of quantum computers (22).

Recently, the TPP-printing of silica glass has been demonstrated (2, 3); however, these approaches are still based on particle-loaded sacrificial polymer binders with limited applicability. To remove the binder and fuse the silica particles into solid structures, several day-long sintering procedures under vacuum or inert atmosphere at 1100-1300° C. are required. These temperatures lie above the melting points of many important engineering semiconductors, like germanium, cadmium telluride, and indium phosphide, which are some of the most efficient materials, for solar cells, infrared- and fiber-optics, lasers, and photodetectors. The same applies to most metals used in electrical circuits. Thus, traditional particle-based silica glass resins are generally not capable of on-chip manufacturing. The only alternative, post-print assembly of microscale components, involves a multitude of challenges (19) and can hardly compete with state-of-the-art assembly routes (14) employing orders of magnitude higher throughput with 2D and 2.5D techniques. In addition, particle-based TPP-resins limit the printing resolution as features approach the length scale of the dispersed particles. The smallest reported free-standing features that are achieved with particle-derived TPP-printed silica are 0.4 μm in size (3), the maximum resolution, i.e. the smallest resolvable spacing of several features, is often two times larger and has not been reported. This spacing is still insufficient for nanophotonic devices for the visible light spectrum, like metalenses (21), 3D bandgap materials (23), and invisibility cloaks (24). Standard TPP with organic resins can print down to 100 nm-size (15) features. Optimized print setups and precursor chemistries can already push below 10 nm (15, 25), smaller than a single nanoparticle of the existing silica-particle TPP-resins. Similar limitations may also apply to the achievable surface quality. Ultimately, the development of dispersions from ever smaller particles is limited, and particle-based approaches may not be able to meet the continuously increasing capabilities of TPP-processes.

The thermal decomposition of organic and organic-inorganic hybrid polymers is a promising particle-free alternative to manufacture inorganic materials. This approach is currently being widely studied for the TPP-fabrication of a range of micro- and nanoscale ceramics. TPP-printing and subsequent heat treatment with organic, pre-ceramic, and sol-gel precursors manufactures 3D nanostructures with feature sizes down to <200 nm in glassy carbon (26), silicon oxycarbide (27, 28) and titania (29), as well as glass-ceramics (30, 31), respectively. The latter can also be visibly transparent and have been used to print optical lenses (31-33), albeit the optical transmission has not been reported. However, the sol-gel approaches are disadvantageous compared to the particle-loaded resins (2, 3) from a processing perspective. They entail tedious pre-print preparations, the hardened gel film state imposes printing constraints, and to densify the final material the TPP-printed templates are also heat treated at 1000-1100° C. (30-32).

Polyhedral oligomeric silsesquioxanes (34, 35) (POSS) are hybrid organic-inorganic polymers composed of cage-like silicon-oxygen frameworks with a general formula (SiO_{1.5}) close to that of fused silica. However, POSS-polymers have so far not been used to TPP-print silica glass. At their corners, the POSS cage-molecules can bond to a large catalog of organic functional groups to enable polymerization into solids with greater resistance to temperature and oxidation than most purely organic polymers. POSS-polymers have been studied for their suitability as templating materials for semiconductors within different lithography techniques (36-38). More recently, epoxy-functionalized POSS resins (39) have successfully been applied in TPP-printing. However, the reported efforts still focused on the synthesis of temperature stable hybrid polymers rather than exploiting the POSS material platform as a precursor to manufacture purely inorganic materials. Thermal decomposition of printed parts has been found to form glass-ceramics with organic impurities and no optical properties have been reported (39). Like sol-gel precursors, epoxy functionalized resins also constrain prints, because printing is performed within spin-coated gel thin films which limits structures to low aspect-ratios on flat substrates.

Accordingly, there is a need for improved methods of printing glass structures at high resolution suitable for photonics applications.

### SUMMARY

In at least one aspect, a method for fabricating glass structures on a substrate is provided. The method includes a step of contacting the substrate with a liquid reactive composition that includes a silsesquioxane, an acrylic oligomer or monomer, and a photoinitiator. The silsesquioxane and the acrylic oligomer or monomer are each independently functionalized with at least two acrylate groups. Light (e.g., a light beam or light projection) is directed to the substrate such that the reactive composition forms a polymeric structure on the substrate. The polymeric structure is heat-treated in an oxygen-containing gas environment at a sufficiently high temperature to convert the polymeric structure to a glass structure. Characteristically, the sufficiently high temperature is lower than the melting point of the substrate.

In another aspect, a method for fabricating glass structures on a substrate is provided. The method includes a step of contacting the substrate with a liquid reactive composition that includes a silsesquioxane, an acrylic oligomer or monomer, and a photoinitiator. The silsesquioxane and the acrylic oligomer or monomer are each independently functionalized with at least two acrylate groups. Two-photon polymerization 3D-printing reactive composition forms a polymeric structure on the substrate. The polymeric structure is heat-treated in an oxygen-containing gas environment at a sufficiently high temperature to convert the polymeric structure to a glass structure. Characteristically, the sufficiently high temperature is lower than the melting point of the substrate.

In another aspect, a method for fabricating ceramic structures on a substrate is provided. The method includes a step of contacting the substrate with a liquid reactive composition that includes a silsesquioxane, an acrylic oligomer or monomer, and a photoinitiator. The silsesquioxane and the acrylic oligomer or monomer are each independently functionalized with at least two acrylate groups. Light (e.g., a light beam or light projection) is directed to the substrate such that the reactive composition forms a polymeric structure on the substrate. The polymeric structure is heat-treated in a vacuum or in an inert gas-containing environment at a sufficiently high temperature to convert the polymeric structure to a carbon-containing ceramic structure. Characteristically, the sufficiently high temperature is lower than the melting point of the substrate.

In another aspect a sinter-free, two-photon polymerization 3D-printing of free-form fused silica nanostructures from a polyhedral oligomeric silsesquioxanes (POSS) resin is provided. Contrary to particle-loaded sacrificial binders, the POSS-resin itself constitutes a continuous silicon-oxygen molecular network, forming transparent fused silica at only 650° C. This is 500° C. lower than the sinter-temperatures for fusing discrete silica particles to a continuum, bringing silica 3D-printing below the melting points of essential microsystem materials. Simultaneously, we achieve a fourfold resolution enhancement, enabling visible-light nanophotonics. Demonstrating unprecedented optical quality, mechanical resilience, ease of processing and coverable size-scale, our material sets the benchmark for the micro/nano-3D-printing of inorganic solids.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements and wherein:

FIG. 1. Schematic flowchart for a method of making high quality glass on a substrate.

FIG. 2A. Schematic of a nanostructures formed by the methods set forth herein.

FIG. 2B. Schematic of a lens composed of the glass structures described herein.

FIG. 2C. Schematic of a meso-scale micro-objective having a plurality of lens that is fabricated by the method set forth herein.

FIG. 2D. Schematic of a diode laser system include a lens system fabricated by the methods described herein.

FIG. 2E. A schematic of an endoscopic device having a lens system 44 fabricated by the methods described herein.

FIG. 2F. A schematic of a photonic integrated circuits connected by waveguides formed from the glass structure described herein.

FIGS. 3A, 3B, 3C, 3D, 3E, 3F, 3G, 3H, and 3I. Fabrication of high-quality fused silica nanostructures from an acrylate-functionalized POSS resin. (A) Schematic synthesis via TPP 3D-printing and subsequent thermal treatment at 650° C. Micrographs of fused silica structures; (B) woodpile photonic crystal with inset optical true-color blue-violet light reflection (front structure) (C) close-up top view of pattern from 97 nm wide lines; (D-E) octet nanolattice comprised of >5000 beams; (F-G) parabolic micro-lenses; (H) 150 μm-tall multi-lens diffractive micro-objective with inset optical micrographs, (I) close-up view of the nanostructured Fresnel lens element. Scale bar in C is 100 nm all others are 10 μm.

FIGS. 4A, 4B, 4C, 4D, 4E, 4F, 4G, and 4H. Material characterization confirming treatment at 650° C. creates pristine fused silica glass. Simultaneous (A) thermogravimetric analysis (TGA), (B) differential scanning calorimetry (DSC), and (C) mass spectrometry illustrate how the polymerized precursor's organic compounds decompose between 350-650° C.; monitored emissions correspond to the mass-to-charge ratios (m/z) of the molecular ions of the indicated substances. (D) Micro-Raman spectra after treatment at increasing temperatures show the conversion of as-printed templates into fused silica at 650° C., (E) bright-field transmission electron microscopy (TEM) images and a selected area diffraction pattern confirm a homogeneous amorphous microstructure, free from detectable pores; (F) electron energy loss spectroscopy (EELS) data confirms the material is composed solely of silicon and oxygen with an atomic ratio closely matching stochiometric SiO₂. (G) Measured diameters of disk-shaped specimens (inset) after exposure to increasing temperatures show the linear contraction of as-printed templates as they convert to fused silica; above 650° C. the final POSS-glass retains perfect geometrical integrity up to 1200° C., with 58±1% of the as-printed size. (H) As-processed fused silica nanolattice before and after high temperature exposure. Scale bars in G and H are 20 μm.

FIGS. 5A, 5B, 5C, 5D, 5E, 5F, and 5G. The TPP-printed POSS-glass enables the fabrication of high-quality free-form micro-optical elements. (A) Free-standing disk-shaped specimens for optical transmission measurements via ultraviolet-visible-near-infrared (UV-Vis-NIR) micro-spectrophotometry. (B) Optical transmission data shows transparency on par with commercial fused silica and exceeding literature reported fused silica (3, 61, 62) from sol-gel, pre-ceramic, and particle precursors, 3D-printed via TPP or digital light processing (DLP), indicated temperatures refer to thermal treatments during manufacturing; the inset shows the area where the UV-Vis-NIR signal was collected. (C) Atomic force microscopy (AFM) data from a flat disk shows optically smooth surface finish (D) Micro-pillar and a measured compressive stress-strain curve demonstrating ultra-high mechanical resilience with tenfold increased strength and stiffness over TPP-printed polymer (17). (E) Aspheric aberration corrected high-precision micro-lenses as optical device demonstrators. (F) Optical profilometry confirms near-ideal accuracy. (G) Images formed by the micro-lenses of a resolution target demonstrate excellent imaging performance; inset contrast intensity profiles show up to 700 line pairs per millimeter are resolved.

FIGS. 6A, 6B, and 6C. Chemical structure of the components comprising the POSS-glass resin. (A) acrylate-functionalized POSS monomer MA0736 with the general formula (RSiO1.5)n, displayed for n=8, (B) trifunctional acrylic monomer SR499, and (C) photoinitiator Irgacure 369.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: all R groups (e.g. Rᵢ where i is an integer) include hydrogen, alkyl, lower alkyl, C₁₋₆ alkyl, C₆₋₁₀ aryl, C₆₋₁₀ heteroaryl, —NO₂, —NH₂, —N(R′R″), —N(R′R″R′″)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, —COO⁻M⁺, —CF₂H, —CF₂R′, —CFH₂, and —CFR′R″ where R′, R″ and R′″ are C₁₋₁₀ alkyl or C₆₋₁₈ aryl groups; single letters (e.g., “n” or “o”) are 1, 2, 3, 4, or 5; in the compounds disclosed herein including compounds described by formula or by name, a CH bond can be substituted with alkyl, lower alkyl, C₁₋₆ alkyl, C₆₋₁₀ aryl, C₆₋₁₀ heteroaryl, —NO₂, —NH₂, —N(R′R″), —N(R′R″R′″)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, —COO⁻M⁺, —CF₂H, —CF₂R′, —CFH₂, and —CFR′R″ where R′, R″ and R′″ are C₁₋₁₀ alkyl or C₆₋₁₈ aryl groups; percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

The term “alkyl” refers to C₁₋₂₀ inclusive, linear (i.e., “straight-chain”), branched, saturated or at least partially and in some cases fully unsaturated (i.e., alkenyl and alkynyl) hydrocarbon chains, including for example, methyl, ethyl, propyl, isopropyl, butyl, isobutyl, tert-butyl, pentyl, hexyl, octyl, ethenyl, propenyl, butenyl, pentenyl, hexenyl, octenyl, butadienyl, propynyl, butynyl, pentynyl, hexynyl, heptynyl, and allenyl groups. “Branched” refers to an alkyl group in which a lower alkyl group, such as methyl, ethyl or propyl, is attached to a linear alkyl chain. “Lower alkyl” refers to an alkyl group having 1 to about 8 carbon atoms (i.e., a C₁₋₈ alkyl), e.g., 1, 2, 3, 4, 5, 6, 7, or 8 carbon atoms. “Higher alkyl” refers to an alkyl group having about 10 to about 20 carbon atoms, e.g., 10, 11, 12, 13, 14, 15, 16, 17, 18, 19, or 20 carbon atoms.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. In the specific examples set forth herein, concentrations, temperature, and reaction conditions (e.g. pressure, pH, etc.) can be practiced with plus or minus 50 percent of the values indicated rounded to three significant figures. In a refinement, concentrations, temperature, and reaction conditions (e.g., pressure, pH, etc.) can be practiced with plus or minus 30 percent of the values indicated rounded to three significant figures of the value provided in the examples. In another refinement, concentrations, temperature, and reaction conditions (e.g., pH, etc.) can be practiced with plus or minus 10 percent of the values indicated rounded to three significant figures of the value provided in the examples.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

Throughout this application, where publications are referenced, the disclosures of these publications in their entireties are hereby incorporated by reference into this application to more fully describe the state of the art to which this invention pertains.

The term “nano-sized” means that a structure has at least one dimension that is less than 100 nm.

The term “micron-sized” means that a structure has at least one dimension that is less than 10 microns.

The term “silsesquioxane” means is an organosilicon compound with the chemical formula [RSiO_{3/2}]n (R=H, alkyl, aryl or alkoxyl) with a cage like structure.

The term “meso scale” generally refers to a range of size or spatial scale between the micro and macro scales. In a refinement, “meso scale” refers to structures having sizes from a micrometer to 10 cm or more.

The term “residue”, means a portion, and typically a major portion, of a molecular entity, such as molecule or a part of a molecule such as a group, which has underwent a chemical reaction and is now covalently linked to another molecular entity. In a refinement, the term “residue” when used in reference to a monomer or monomer unit means the remainder of the monomer unit after the monomer unit has been incorporated into the glass structure.

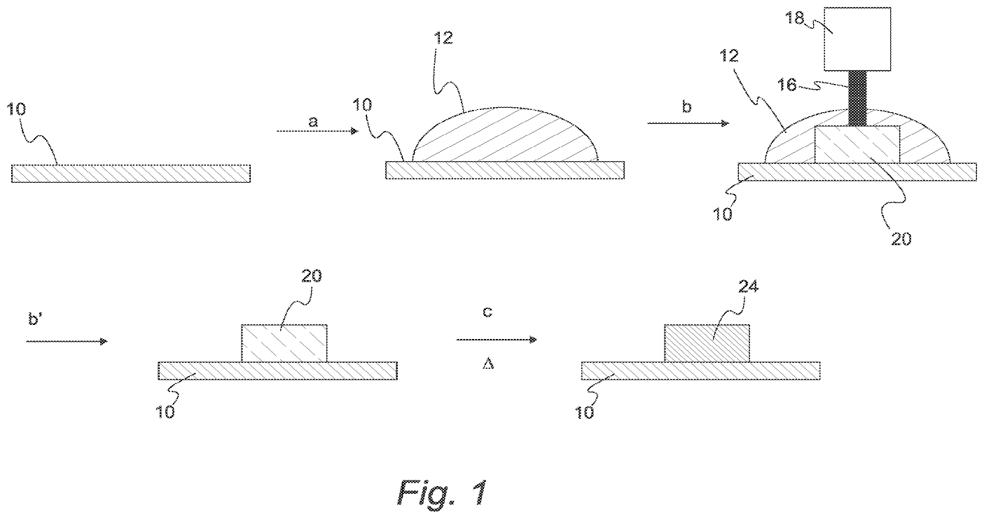

Referring to FIG. 1, a schematic depicting a method for fabricating glass structures on a substrate is provided. In step a), substrate 10 is contacted with liquid reactive composition 12. Characteristically, the liquid reactive composition 12 includes a silsesquioxane, acrylic oligomer or monomer, and a photoinitiator, the silsesquioxane and the acrylic oligomer or monomer each independently being functionalized with at least two acrylate-containing groups. In a refinement, all of the silane atoms in the silsesquioxane are functionalized with acrylate-containing groups. In step b), light 16 from light source 18 (e.g., a laser) is directed to substrate 10 such that reactive composition forms a polymeric structure 20 on the substrate. In a particularly useful variation, this step is a two-step polymerization printing step. In other variations, this step is a two-photon polymerization printing step. In a refinement, light source 18 is a pulsed laser, and in particular, a femtosecond laser (e.g., for two photon polymerization. In another variation, step b) is a linear (one-photon) photopolymerization step. For printing applications, the light can move relative to the substrate to form a patterned polymeric coating on the substrate that is converted to a patterned glass after being thermally treated. When using light, a pattern can be made in the following three ways: 1) laser beam moving in a fixed resin following pattern trajectory; 2) resin moving around a fixed laser following pattern trajectory; 3) method 1) and 2) performed simultaneously. In step b′), the unreacted liquid is washed away. In step c), polymeric structure 20 is treated at a sufficiently high temperature in an oxygen-containing gas (e.g., air) to convert the polymeric structure to a glass structure 24. Advantageously, the sufficiently high temperature is lower than the melting point of the substrate. Advantageously, the method described here can form 3 dimensional nano-sized or micron-sized glass structures that are suitable for photonics applications such as waveguides and photonic interconnect on a semiconductor chip. Moreover, the glass structure fabricated herein are also useful for micro-optics and photonics, MEMS, micro-fluidic and biomedical devices, to fundamental research. Therefore, lens and compound lens systems can also be fabricated.

In a refinement, the sufficiently high temperature is from about 500° C. to about 800° C. In another refinement, the sufficiently high temperature is less than, increasing order of preference, 1000° C., 900° C., 800° C., 700° C., or 650° C. In a further refinement, the sufficiently high temperature is greater than, increasing order of preference, 450° C., 500° C., 550° C., 600° C., or 625° C.

As set forth above, step b is most advantageously performed by two-photon polymerization. However, it should be appreciated that other photocuring printing techniques can also be used. Examples of such techniques includes but are not limited to stereolithography, two step lithography or photoinhibition lithography (PIL).

In a variation, the silsesquioxane is described by [RSiO_{3/2}]ₙ, n is an even positive integer, R is H, C₁₋₆ alkyl, C₁₋₆ alkoxyl, or an acrylate-containing group with the proviso at least two of R₁, R₂, R₃, R₄, R₅, R₆, R₇, R₈ are an acrylate-containing group. In a refinement, n is 6, 8, 10, or 12. An example of an acrylate-containing group is

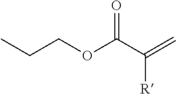

where m is an integer from 1 to 5 and R′ is H or methyl.

In a refinement, the silsesquioxane is described by formula 1:

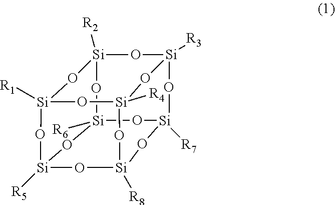

wherein R₁, R₂, R₃, R₄, R₅, R₆, R₇, R₈, are each independently H, C₁₋₆ alkyl, C₁₋₆ alkoxyl, or an acrylate-containing group with the proviso at least two of R₁, R₂, R₃, R₄, R₅, R₆, R₇, R₈ are an acrylate-containing group. An example of acrylate-containing group is set forth above. In a refinement, each of R₁, R₂, R₃, R₄, R₅, R₆, R₇, R₈ are an acrylate-containing group. In a variation, the silsesquioxane is described by formulae 2, 3, or 4:

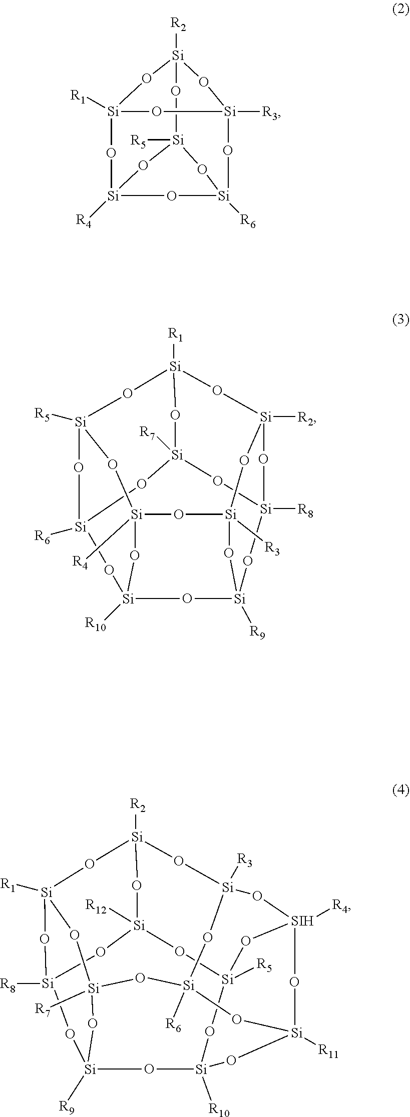

wherein R₁, R₂, R₃, R₄, R₅, R₆, R₇, R₈, R₉, R₁₀, R₁₁, R₁₂ are each independently H, C₁₋₆ alkyl, C₁₋₆ alkoxyl, or an acrylate-containing group with the proviso at least two of R₁, R₂, R₃, R₄, R₅, R₆, R₇, R₈, R₉, R₁₀, R₁₁, R₁₂ are an acrylate-containing group. In a refinement, each of R₁, R₂, R₃, R₄, R₅, R₆, R₇, R₈, R₉, R₁₀, R₁₁, R₁₂ are an acrylate-containing group. An example of acrylate-containing group is set forth above. The silsesquioxane can be designated as T₆, T₈, T₁₀, and T₁₂.

In another variation, the acrylic oligomer or monomer is described by formula 5:

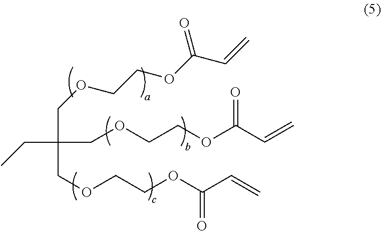

and a, b, c are each independently 1 to 6.

In a variation, the acrylic oligomer or monomer is described by formula 6:

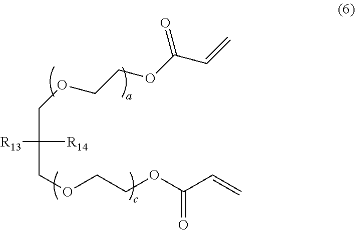

wherein R₁₃, R₁₄ are each independently H or C₁₋₆ alkyl and a, b, c are each independently 1 to 6.

In another variation, the acrylic oligomer or monomer is described by formula 6 or 7:

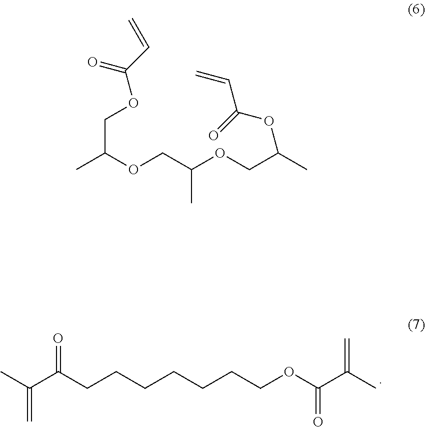

A number of different photoinitiators such as acyl-phosphine oxides, alpha-aminoalkyl-phenomes, thio-xanthones/amine can be used as known to those skilled in the art. A particular example is Omnirad 369″369 (2-Benzyl-2-(dimethylamino)-1-[4-(morpholinyl) phenyl)]-1-butanone) commercially available from IGMResins.

In another embodiment, a method for fabricating ceramic structures on a substrate is provided. The method includes a step of contacting the substrate with a liquid reactive composition that includes a silsesquioxane, an acrylic oligomer or monomer, and a photoinitiator. The silsesquioxane and the acrylic oligomer or monomer are each independently functionalized with at least two acrylate groups. Light (e.g., a light beam or light projection) is directed to the substrate such that the reactive composition forms a polymeric structure on the substrate. The polymeric structure is heat-treated in a vacuum or in an inert gas-containing environment at a sufficiently high temperature to convert the polymeric structure to a carbon-containing ceramic structure. Characteristically, the sufficiently high temperature is lower than the melting point of the substrate. Details for the silsesquioxane, the temperature, and other reaction conditions are the same as set forth above.

In another embodiment, a glass structure formed by the methods set forth herein is provided. The glass structure includes residues of a silsesquioxane, acrylic oligomer or monomer, and a photoinitiator. As set forth above, the silsesquioxane and the acrylic oligomer or monomer each independently being functionalized with at least two acrylate groups. Advantageously, the glass structure includes carbon in an amount of less than 1 weight percent of the total weight of the glass structure. In some refinement, the glass structure includes carbon in an amount of less than, in increasing order of preference, 1 weight percent, 0.5 weight percent, 0.1 weight percent, 0.05 weight percent, 0.01 weight percent, or 0.005 weight percent. In other refinements, the glass structure includes carbon in an amount of 0 weight percent of the total weight of the glass structure. Advantageously, the glass structure can be a 3 dimensional nano-sized or micron-sized structure. Details of the silsesquioxane, acrylic oligomer or monomer, and a photoinitiator are set forth above.

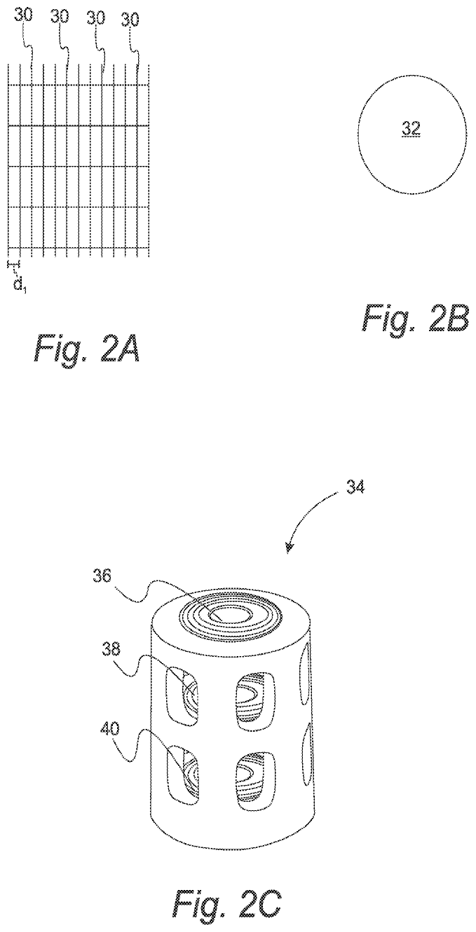

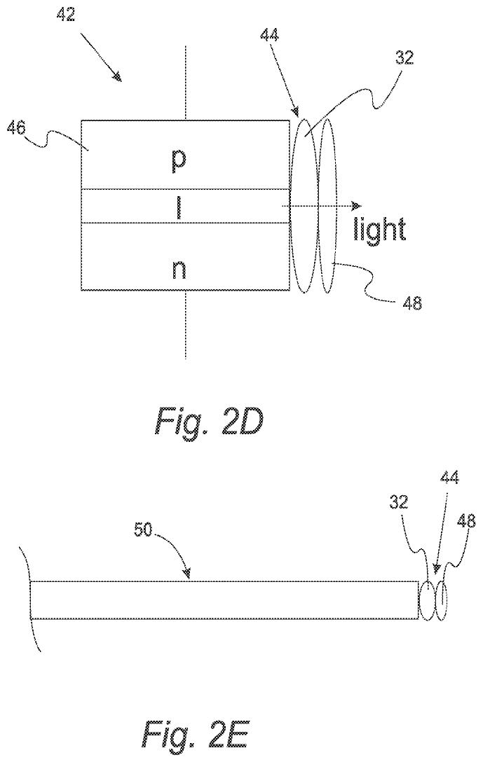

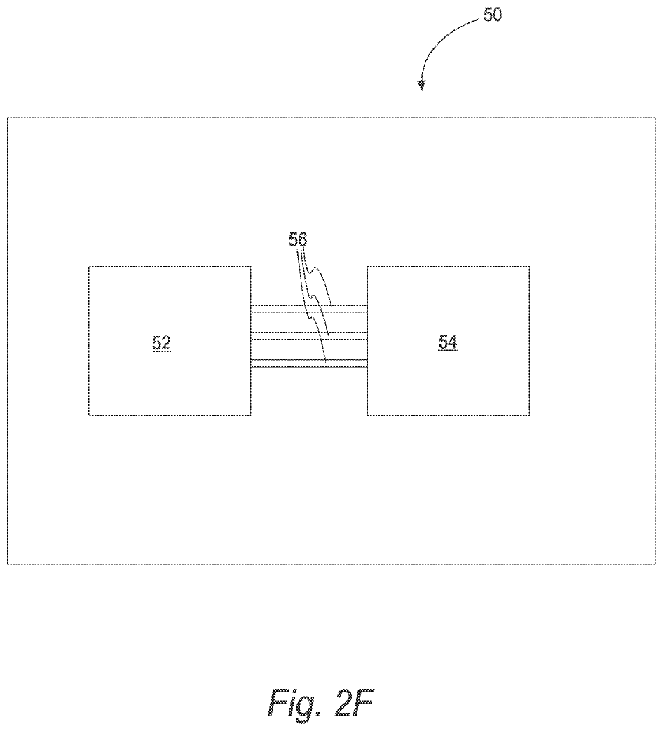

Referring to FIGS. 2A, 2B, 2C, and 2D, schematics of optical devices including the glass structures described above are provided. In many applications, the glass structures include one or more nanostructures. Typically, the nanostructures have at least one dimension from about 20 nm to 300 nm. In some variations as depicted in FIG. 2A, the nanostructures include rods 30 having a spacing di from about 50 to 500 nm. FIG. 2B depicts a lens composed of the glass structures described herein. Lens 32 can be fabricated with diameters from about 50 to 300 microns. It should be appreciated the methods described can be used to form convex lens, concave lenses, bi-convex lenses, bi-concave lenses, plano-convex lenses, plano-concave lenses, and the like. The sag for such lens can be from 5 to 100 nm. FIG. 2C depicts an example of a meso-scale micro-objective having a plurality of lens that is fabricated by the method set forth above. Micro-objective 34 includes lens layers 36, 38, and 40.

FIG. 2D provides a schematic of a diode laser system 42 including a lens system 44 that includes lens 40 and a diode laser 46. It should be appreciated that lens system 44 can include a single lens 40 or a compound lens system. Such a compound lens system can include multiple lenses 40 and 48 each formed from the glass structures described herein. In a refinement, the lens system can be directly deposited on the diode laser by the methods described herein.

FIG. 2E provides a schematic of an endoscopic device 50 having a lens system 44 that includes lens 32 and one or more image fibers (typically a plurality of image fibers). It should be appreciated that lens system 44 can include a single lens 40 or a compound lens system. Such a compound lens system can include multiple lens 40 and 48 each formed from the glass structures described herein. In a refinement, the lens system is positioned at a distal tip of the endoscope. In a further refinement, the lens system is directly deposited on the image fibers.

FIG. 2F provides a schematic of a photonic integrated circuit connected by waveguides formed from the glass structure. In general, a waveguide connecting two or more photonic integrated circuits can be formed. Photonic device 50 includes photonic integrated circuits 52 and 54 that are in optical communication through waveguides 56. Waveguides 56 are composed of the glass described herein.

In another example, a micro-concentrator for solar cells including the lens system is provided. In still another example, a hemispherical resonator gyroscope including the glass composition or structure is provided. hemispherical resonator gyroscopes typically includes a hollow spherical cell that can be composed of the glass composition described above.

The following examples illustrate the various embodiments of the present invention. Those skilled in the art will recognize many variations that are within the spirit of the present invention and scope of the claims.

Herein, we introduce a sinter-free, low-temperature two-photon polymerization 3D-printing route, fabricating complex transparent fused silica glass nanostructures via a particle-free organic-inorganic POSS precursor (FIG. 2).

### Resin Formulation

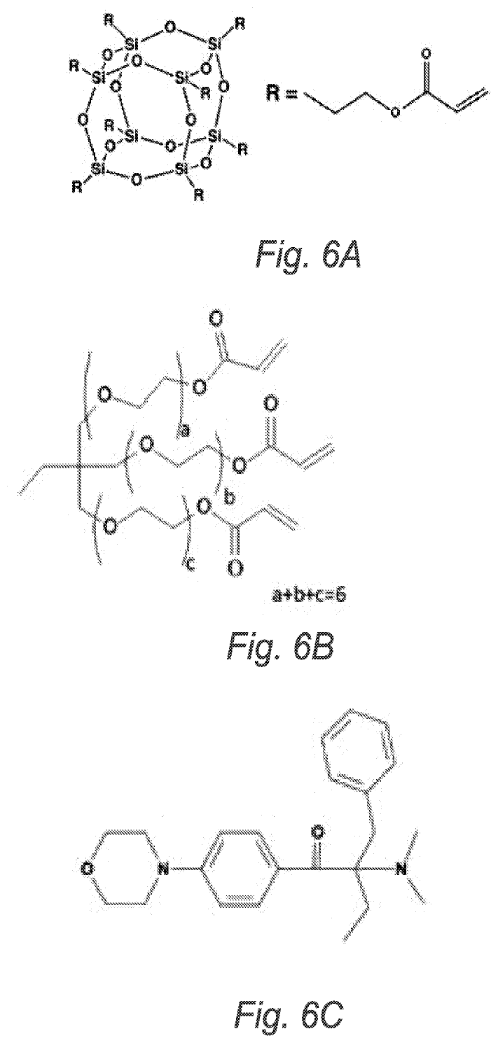

Our POSS-glass resin is a negative-tone TPP photoresist composed from three parts, each of which contributes a specific set of functionalities (FIG. 6); (i) 89 wt % acrylate-functionalized POSS monomer, (ii) 9 wt % trifunctional acrylic monomer, and (iii) 2 wt % photoinitiator of the α-aminoketone family (40). The POSS monomer, was the main component, whose POSS-cage-cores constituted the silicon-oxygen nanocluster source enabling the SiO₂ conversion. Its acrylic functional groups were essential to achieve high-performance TPP. Acrylate-based resins are the most widely used TPP material class (41, 42) due to their processing ease and wide assortment of functionalities and monomer sizes (43). Contrary to epoxy or sol-gel TPP resins, the acrylic reaction kinetics (44) allow printing in a liquid state with a high polymerization rate (45). However, the rigid structure of POSS monomers generally prevents the formation of sufficiently cross-linked (15, 46) self-supporting TPP-printed parts. Reported epoxy-POSS TPP-resins are limited to 10-60 wt % POSS-loading (39). In our material, the conformational flexibility of the small addition of the long-armed, branched trifunctional acrylate facilitates reproducible TPP-printing despite the high POSS-loading of 89 wt %, and provides important resilience against cracking (47). This was key to print structures with a sufficiently close packing of silicon-oxygen nanoclusters, which successfully converted to dense SiO₂ at low temperatures. Further, the branched trifunctional acrylate's its concentration allowed control over the resin's viscosity (48). Acting as an eluent modulating the diffusion of radicals and dissolved molecular oxygen, this enabled the resin to print finely resolved features. The chosen photoinitiator induced copolymerization of the resin's acrylic groups via light exposure. We selected it for its efficient radical generation quantum yield, nonlinear absorption, and primary radical reactivities at the excitation wavelength of 780 nm of the utilized TPP system (49, 50).

We synthesized the POSS-glass resin via a mixing and heating procedure of the above three components (51), obtaining a clear, light-yellow liquid which is stable at ambient conditions for several years and readily usable for TPP-printing. We optimized the final mixture's composition ratio to maximize its silicon-oxygen nanocluster content while retaining excellent printability, as confirmed by TPP-printed calibration grids.

### Facile Fabrication of Complex Nanostructures

TPP-printing of 3D polymer template structures followed simple standard procedures (15) using a commercial TPP system. Therein, the resin was drop cast onto fused silica or silicon substrates and the printer's magnification objective was directly immersed in the resin. The objective focused an ultrafast pulsed laser beam into the resin. Within the focal volume, simultaneous absorption of two photons by the photoinitiator molecules results in their homolytic cleavage, forming two radicals. These initiated the cross-linking of the monomers' acrylate groups, transforming the resin into a solid network, comprised of an organic matrix with embedded silicon-oxygen POSS nanoclusters. 3D structures were printed by in-plane scanning of the focused laser beam via galvanometer mirrors and by 3-axis motion of the piezoelectric sample stage. In contrast to reported TPP-printed epoxy-functionalized POSS (39), pre-ceramic (29), and sol-gel (30) resins, no pre-treatments restricting immersion oil and spacer layers, or alike were required. After printing, a 20 min-long isopropanol alcohol development bath dissolved the remaining uncured resin. The fabricated specimens were either dried in air, or, for the case of the most delicate structures, supercritically dried to prevent damage from capillary forces.

Moderate thermal treatment to only 650° C. in an air atmosphere converted the as-printed polymer templates to fused silica structures. Accompanied by an isotropic linear contraction of about 40%, the elevated temperature decomposed and degassed the organic compounds, with the atmospheric oxygen removing the remaining elemental carbon. Therein, our POSS templates' densely-packed continuous silicon-oxygen molecular networks constituted the crucial feature circumventing the extreme temperatures which are otherwise required to sinter discrete silica particles to a continuum (1-3).

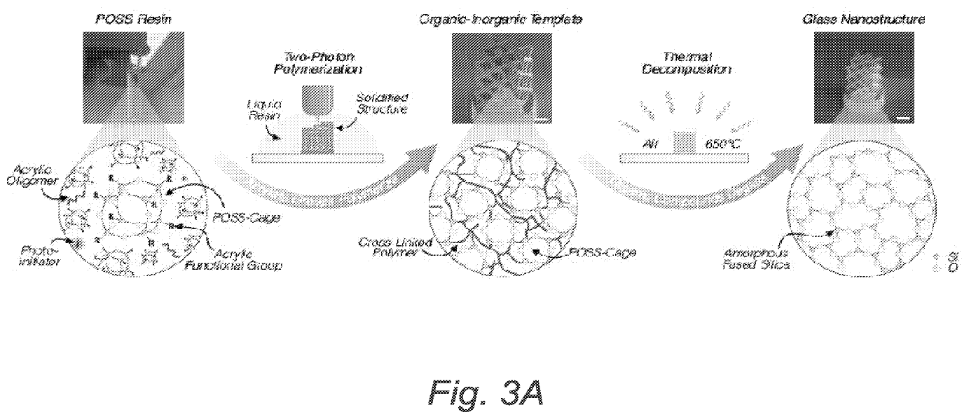

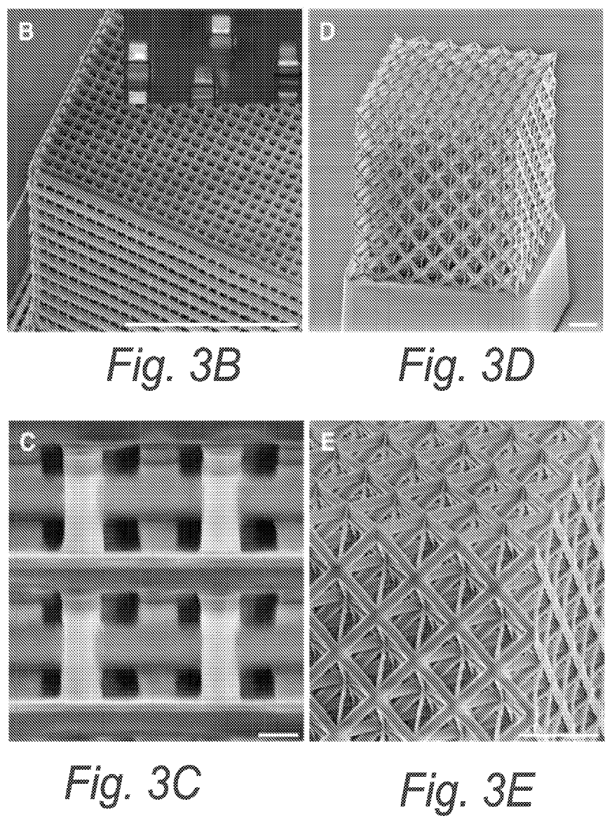

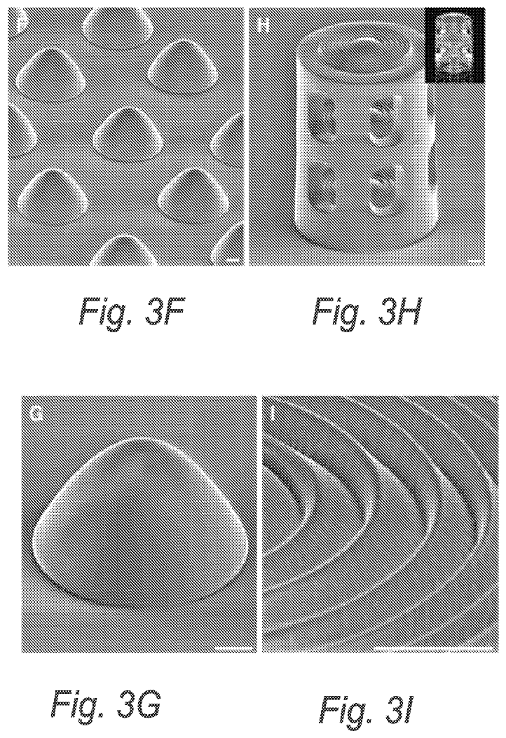

We demonstrate a variety of 3D fused silica glass micro- and nanostructures (FIG. 3B-I), outperforming the resolution, structure quality, and coverable size-scale of previously reported inorganic TPP-printed materials. We fabricated woodpile photonic crystals comprised of 97 nm-size free-standing features (FIG. 3B-C). This constitutes a fourfold improvement over existing TPP-printed fused silica (3) and matches the smallest reported features of inorganic TPP structures (30) in general. Moreover, the feature quality we achieved substantially outperforms that of the previously reported comparably resolved structures (30). The photonic crystal we synthesized had a rod spacing of 350 nm, demonstrating the capability to realize nanophotonic structures at wavelengths approaching the ultraviolet (UV) regime (24, 52). The optical micrograph (FIG. 3B, inset) shows the structure reflecting light of blue-violet color, along with photonic crystals that adjust colors of longer wavelength by larger rod spacings. Furthermore, we printed pristine nanolattice metamaterials comprised of thousands of individual bars (FIG. 3D-E), smoothly shaped aspherical micro-lenses (FIG. 3F-G), and complex meso-scale micro-objectives (FIG. 3H-I) with ˜150 μm overall size, containing diffractive lens elements with nanoscale details. Overall, our POSS-glass process achieved a level of print quality, complexity, and coverable size-scale previously only realizable with polymeric structures from standard organic resins.

### Materials Characterization

Our material characterization confirmed moderate thermal treatment at only 650° C. in air atmosphere successfully converted the POSS-resin to pure fused silica. FIG. 3 shows the results from combined thermogravimetric analysis (TGA), differential scanning calorimetry (DSC) and mass spectrometry, as well as micro-Raman spectroscopy, and transmission electron microscopy (TEM).

Combined TGA, DSC and mass spectrometry identified the glass conversion of our material to take place between 350-650° C. (FIG. 3A-C). The material underwent a total mass loss of approximately 65%, with three mass derivative peaks at 415, 480 and 595° C., correlating with three exothermal peaks of the heat flow data. Each of these peaks corresponded to three consecutive reaction stages which are distinct to the thermo-oxidative degradation of highly crosslinked acrylic polymers (53, 54). In the first and second stages, these reaction paths include the formation of peroxide groups, followed by random chain scission and volatilization of produced species, such as water, carbon dioxide, hydrocarbons, alcohols, and higher mass species (53, 55). Mass spectrometry of the exhaust gasses confirmed this fragmentation, as monitored by the molecular ions of acetylene (C₂H₂), 1,2-ethanediol (C₂H₆O₂), and methylpropionate (C₄H₈O₂). During the first reaction stage, emissions of all the above species were present simultaneously with CO₂ and H₂O. The second stage continued the decomposition, however no further higher mass species were formed. In the third and final reaction stage, only CO₂ and H₂O emissions passed through a maximum, with no increase in emissions of monomer related ions. This indicates the final reaction stage as the complete oxidation of remaining stable hydrocarbon impurities. We confirmed this by a control TGA/DSC experiment in inert atmosphere. The inert decomposition also included the first two reaction stages, which are primarily temperature-driven (54, 55), however, completed without a third stage, forming chars with significant amounts of residual carbon. Above 650° C., neither TGA nor DSC showed any notable further changes, indicating complete volatilization of all organic constituents, leaving an inorganic material behind. In general, oxidizing atmospheres accelerated the decomposition processes (55). In pure oxygen atmosphere the decomposition of our material completed at approximately 600° C.

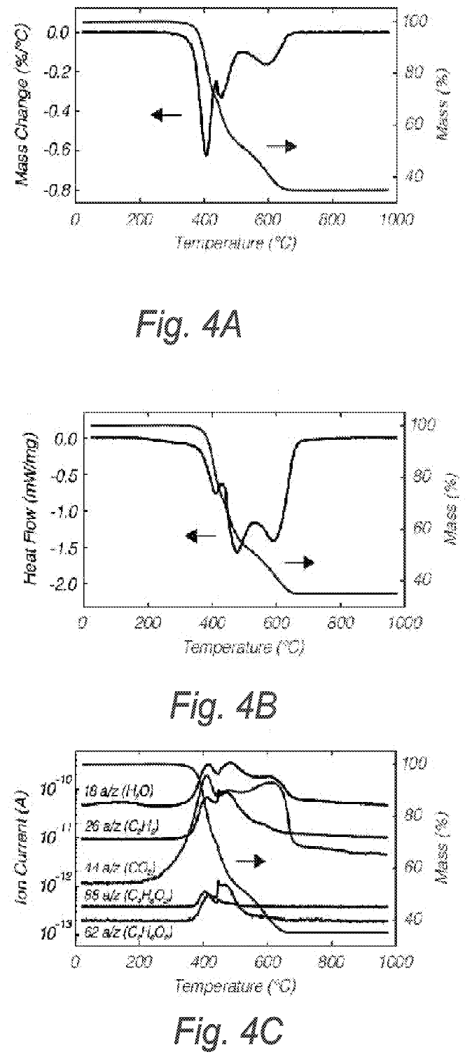

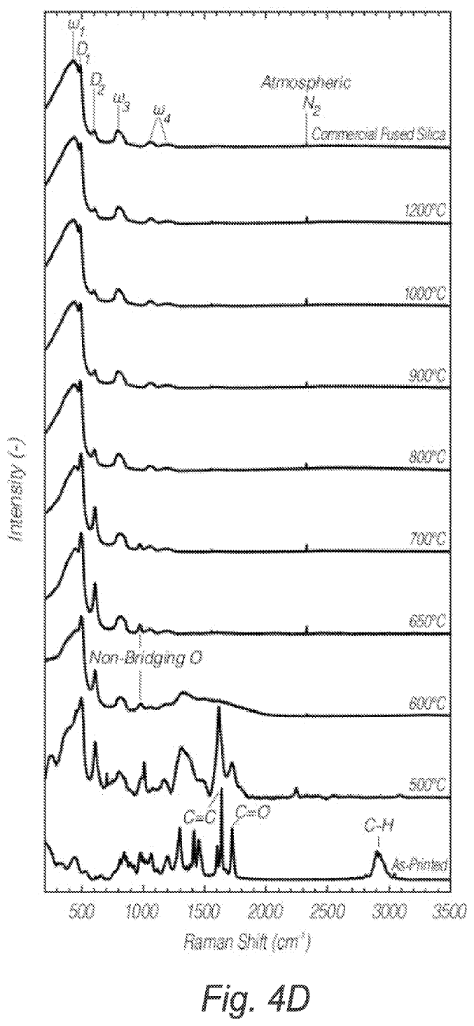

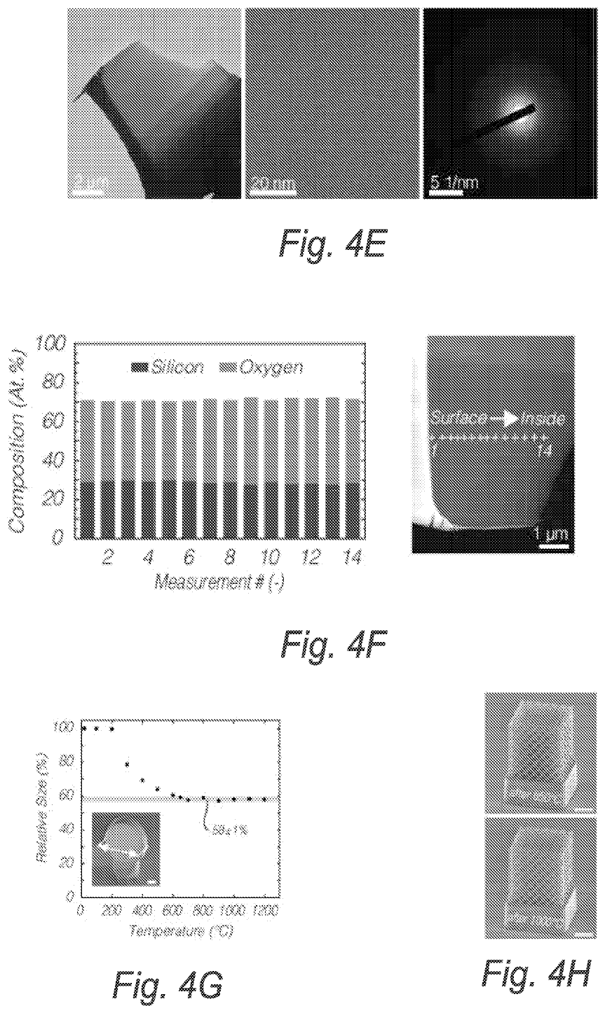

Micro-Raman spectroscopy measurements after thermal treatment at progressively increasing temperatures demonstrated the conversion of as-printed organic-inorganic POSS-structures into fused silica (FIG. 4D). As a reference, we provide the spectrum of commercial fused silica. Therein, the ω₁ and ω₃ bands correspond to bending vibration of the Si(O_{1/2})₄ tetrahedrons' Si—O—Si bridges, and the ω₄ bands are attributed to the stretching motion of their Si—O bonds (56). The D₁ and D₂ lines relate to the symmetric stretching of silicon-oxygen ring molecules (56). Distinct from the fused silica signal, the spectrum of as-printed POSS-structures was typical of a thermoset, where the strongest peaks represent the carbon-carbon (1630 cm⁻¹) and carbon-oxygen double bonds (1720 cm⁻¹), whose intensity ratio can be used to quantify the extent of cross-linking between the acrylic chains (17). The signal around 2900 cm⁻¹ corresponded to the characteristic aliphatic and aromatic stretching modes of the carbon-hydrogen single bonds (57). At 500° C., the organic microstructure had partially disappeared, such as demonstrated by the absence of the 2900 cm⁻¹ signal. The remaining associated peaks became smaller and notably broadened, indicative of increasing disorder. This observation is consistent with the above simultaneous thermal analysis, confirming the fragmentation and removal of a substantial portion of the material's organic groups in the first two reaction stages. Simultaneously, the typical signal of fused silica below 1000 cm⁻¹ began to appear. This shows, the material's silicon-oxygen POSS-cage nanoclusters, which are initially solely connected through the cross-linked organic matrix, directly start to form a continuous inorganic silica network as organic groups decompose and volatilize. Above 600° C. the organic peaks disappeared entirely, and the spectra took the characteristic fused silica shape, indicating the material had completely transformed into SiO₂ at 650° C. In agreement with the TGA, DSC and mass spectroscopy results, the spectra collected after treatments above 650° C. revealed the absence of any further compositional changes and only showed some microstructural reorganization. Between 650-800° C., the decreasing intensity of the D₁ and D₂ lines with respect to the ω₁ band indicated the transition of 4- and 3-membered ring molecules, which may have been inherited from the POSS-cage structure, towards tetrahedrons. The disappearance of the small peak at 972 cm⁻¹ above 700° C. indicated the elimination of a trace amount of tetrahedral silica with two non-bridging oxygens (58). Above 800° C. the spectra of the POSS-glass and commercial fused silica were identical, and no further changes were observed up to the maximum temperature tested, 1200° C.

We used TEM to confirm our POSS-glass is pristine SiO₂. We took measurements on a lamella extracted from the center plane of a 10 μm diameter micropillar. Bright-field TEM micrographs showed a homogeneous amorphous phase without any detectable pores, which we confirmed by selected area diffraction of the interior of the lamella (FIG. 4E). We determined the composition by electron energy loss spectroscopy (EELS) at 14 points along the center axis of the lamella at varying distances from the top surface of the pillar (FIG. 4F). We did not detect impurities and the material consisted solely of silicon and oxygen, closely matching stochiometric SiO₂. We measured atomic percentages of 29±1 at. % silicon and 71±1 at. % oxygen, the typical uncertainties associated with the individual EELS quantifications are on the order of 2-4 at. % (59, 60).

While processed at only 650° C., the POSS-glass retained perfect geometrical integrity upon high temperature exposure, consistent with the demonstrated chemical stability. Dimensional characterizations after exposure to increasing temperatures, from the as-printed polymer-template-state up to 1200° C., show the TPP-printed template structures underwent isotropic linear contraction of 42±1% during their thermal conversion. After 650° C. the resulting fused silica retained perfect geometrical integrity up to 1200° C., without measurable further shrinkage (FIG. 4G). Correspondingly, even the most delicate nanoarchitectures weathered higher temperatures without any distortion, fusion, or other damage (FIG. 4H).

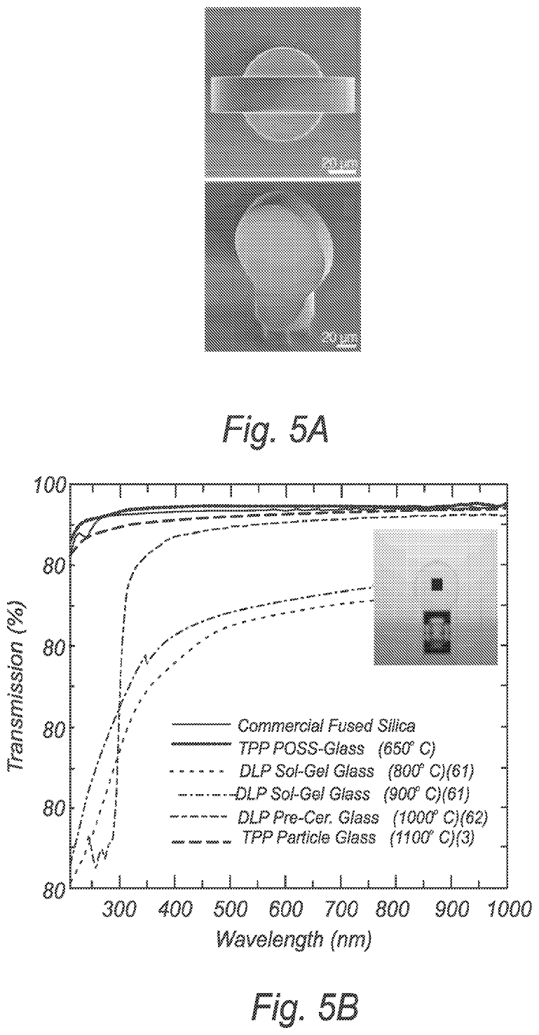

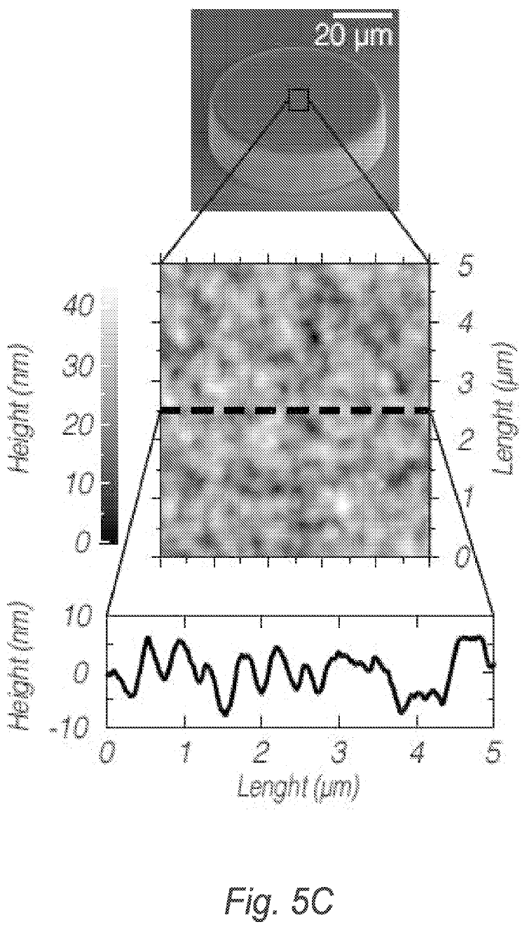

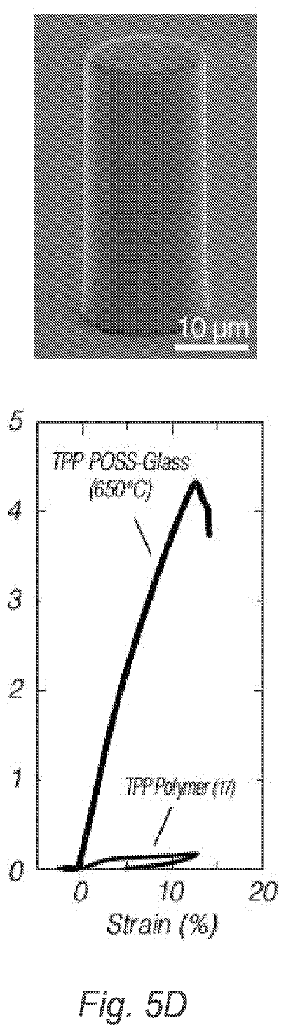

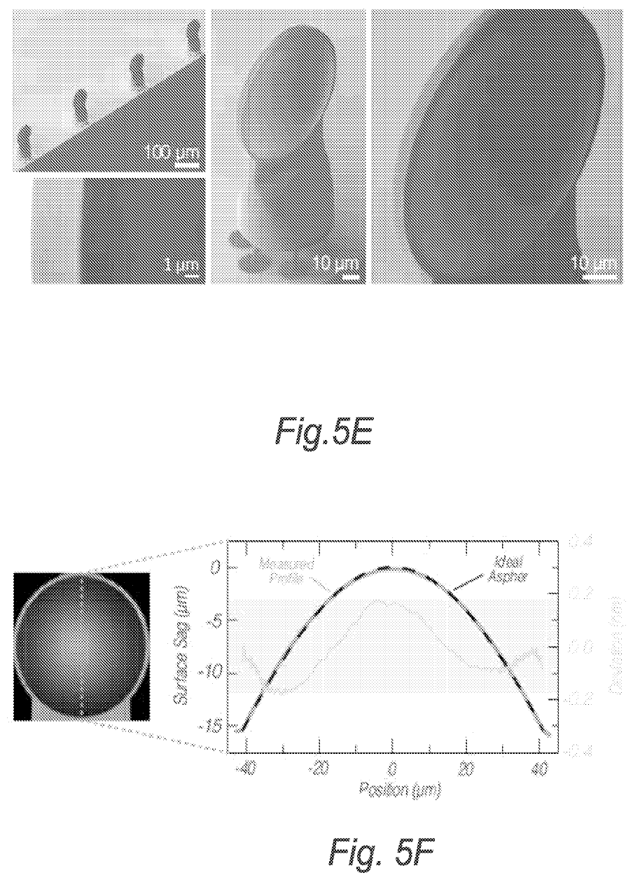

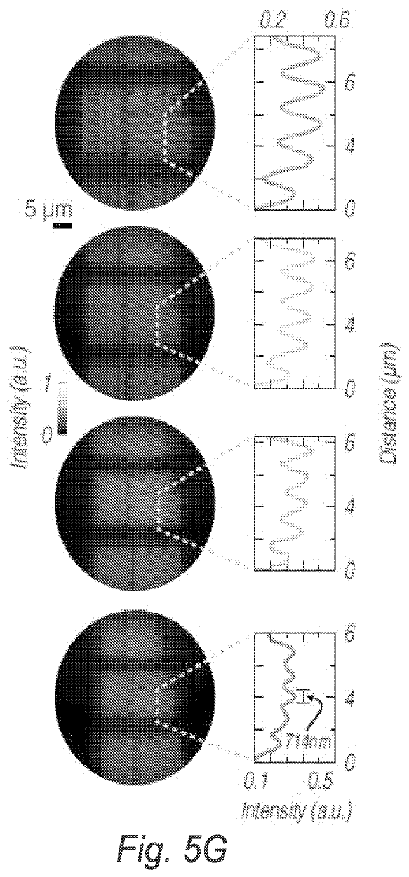

Despite being processed at considerably lower temperatures, the optical transparency of our 3D-printed POSS-glass exceeded that of previously reported additively manufactured forms of fused silica. We conducted ultraviolet-visible-near-infrared (UV-Vis-NIR) micro-spectrophotometry measurements with free-standing, 25 μm-thick disk-shaped specimens that were TPP-printed from our POSS-precursor and converted to fused silica at 650° C. (FIG. 5A). The POSS-glass had excellent optical transmission, on par with commercial fused silica. Across the measurement range from the UV to the NIR spectrum, no absorption bands were present (FIG. 5B). By contrast, the transmission of silica glasses from sol-gel precursors (61), that have been 3D-printed at the macro-scale and processed at 800° C., are reportedly limited to about 70% and almost completely opaque in the UV-range. Also, the particle-derived TPP-printed fused silica (3), sintered at 1100° C., did not quite reach the transmission of the POSS-glass. Consistent with the demonstrated structural thermal stability, exposure to 1000° C. did not notably alter the transmission of our material.

The POSS-glass further achieves optically smooth surface finish and ultra-high mechanical strength. Atomic force microscopy (AFM) on a flat disk measured a root mean square (RMS) roughness of 5.5 nm (FIG. 5C). Compression of POSS-glass micropillars treated at 650° C. showed elastic-plastic behavior with notable plastic deformability and 4.0±0.2 GPa strength (FIG. 5D). Granted by the small scale, which limits the probability of preexisting flaws, this value is four times as high as the compressive strength of bulk UV-grade fused silica (63). Comparably beneficial mechanical behavior has been reported for opaque TPP-derived pyrolytic carbon (64, 65). Treatment at 1000° C. was found to further increase the strength of the POSS-glass (51). The measured Young's moduli of up to 67 GPa were within the range of common forms of dense fused silica (66). Our POSS-glass possesses more than an order of magnitude higher strength and stiffness (17), than the state-of-the-art polymers that hold the current benchmark for TPP-printed high-fidelity micro-optics.

### Optical Device Demonstration

We demonstrate our material enables the fabrication of free-form fused silica glass micro-optical elements with excellent optical performance (FIG. 5E-G). Lens systems for imaging and beam shaping are among the most important micro-optical devices. However, the highest-precision glass micro-lenses (67) have thus far been fabricated by subtractive top-down approaches, which are limited to simple designs that for example cannot correct for aberrations. Herein, we TPP-printed plano-convex fused silica micro-lenses with an aspheric profile, which was numerically optimized to correct for spherical aberrations. The final POSS-glass lenses with a base-diameter of 82 μm and 15 μm sag height, were treated at 650° C. and were of pristine structural quality with finely resolved nanoscale contours and smooth surfaces (FIG. 5E). We conducted optical profilometry measurements (FIG. 5F) to confirm the excellent shape accuracy with a peak-to-valley (PV) deviation of the lens profile with respect to the aspheric design of ±175 nm. The measured RMS roughness was 8.1 nm, which translates to an RMS-to-sag ratio of 0.05%. These values are on par with the latest achievements with polymeric TPP-printed lenses (68), which report shape deviations of 0.1-0.5 m and 4-15 nm RMS roughness, and within the specifications of the highest-quality commercial glass micro-lenses fabricated by reactive ion etching or ion exchange techniques, for which RMS-to-sag ratio of 0.01-0.09% are reported (67). Optical resolution measurements with a 1951 USAF-type resolution target under white light illumination demonstrated the excellent imaging performance of our micro-lenses. FIG. 5G shows images formed by the micro-lenses of the target, which we projected onto a CMOS camera sensor with an optical microscope system. The visible labels indicate the respective pattern elements' number of line pairs per millimeter (lp/mm). the inset graphs show the measured intensity contrast between adjacent line elements. We were able to resolve up to 700 lp/mm with approximately 6% remaining contrast with our micro-lenses, meaning 714 nm-size features remained distinguishable. This approximately corresponds to group 9, element 4 of the 1951 USAF target, which notably outperforms previously reported inorganic plano-convex micro-lenses which were TPP-printed from sol-gel precursors (31, 33, 69), whose resolution capability is reported within group 4-7 of the 1951 USAF target.

### CONCLUSION

The POSS-glass TPP 3D-printing route may help redefine the paradigm for the free-form manufacturing of silica glass, overcoming fundamental limitations of the particle-based approaches, that have dominated the field. The crucial innovation of our approach lies in the developed POSS-resin, which, contrary to a particle-loaded binder, is not sacrificial but itself polymerizes into a continuous silicon-oxygen molecular network. Hence, the material circumvents extreme temperatures, otherwise required to sinter discrete silica particles to a continuum (1-4), enabling conversion to fused silica at only 650° C. Constituting a temperature reduction of about 500° C. with respect to the best reported TPP-approaches (2, 3), this brings the free-form synthesis of silica glass below the melting points of essential materials for microsystems technology, including silver, copper, gold, and aluminum. This represents a breakthrough enabling the evolution of on-chip 3D-printing of transparent matter from state-of-the-art organic polymers to resilient optical-grade fused silica. Similarly, Our POSS-glass process breaches the critical resolution limit to realize free-form silica nanophotonic devices in the visible light spectrum (24, 52) while simultaneously being capable of manufacturing hundreds of micrometer-size high-aspect-ratio structures. Overall, we achieved attractive combinations of optical quality, mechanical resilience, processing ease, and coverable size-scale, setting the benchmark for the micro- and nanoscale 3D-printing of inorganic solids in general.

Potential fields of application of our POSS-glass are widespread, ranging from micro-optics and photonics, MEMS, micro-fluidic and biomedical devices, to fundamental research. Examples include; aging and environment resistant ultra-compact imaging systems (18), for applications from medical endoscopes to consumer electronics; superior-accuracy sensors, whose 3D design today typically limits them to centimeter-size devices for costly applications like deep space missions (70); as well as beam shaping elements (19) for the end faces of diode lasers, which are the basic components for most high-power laser applications, but whose output power cannot be sustained by polymers. In fracture mechanics research, fused silica is a model material (71), however, specimen geometries are often non-trivial and challenging to manufacture. The design-freedom of our POSS-glass process enables to systematically investigate fracture mechanisms at smallest scale, including within metamaterials, like nanolattices (72, 73).

### Materials and Methods

### Poss-Glass Resin Composition

Our POSS-glass resin is a negative-tone TPP photoresist consisting of three parts (FIG. 6): (i) 89 wt % acrylic polyoctahedral silsesquioxanes (MA0736, Hybrid Plastics) as an organic-inorganic monomer with the general formula (RSiO1.5)n with R=C6H9O2 and n=8, 10, 12, which is comprised of an inorganic silicon-oxygen cage core bonded to organic acryloxypropyl groups at each of the Si atom corners; (ii) 9 wt % ethoxylated (6) trimethylolpropane triacrylate (SR499, Sartomer) as a branched acrylic monomer with high conformational flexibility and; (iii) 2 wt % 2-benzyl-2dimethylamino-4′-morpholinobutyrophenone (Irgacure 369, CIBA Specialty Chemicals) as a photoinitiator of the □-aminoketones family (73), which homolytically breaks into two radical fragments via a Norrish type I mechanism upon two-photon absorption in the NIR range. All three components were used as received from the manufacturers.

### Poss-Glass Resin Preparation

To prepare the resin, first the POSS monomer was mixed with the trifunctional acrylic monomer. A homogenous mixture was obtained by stirring the two components for 10 min using a test tube rotator. Subsequently, the photoinitiator powder was added to the mixture in a UV-protected environment. The mixture was stirred for 24 hrs, allowing for the majority of the photoinitiator to dissolve. Finally, heat treatment at 75° C. for 12 hrs dissolved any residual photoinitiator particles resulting in a clear and homogenous mixture. After being cooled to room temperature, the final POSS-glass resin was readily usable for TPP-printing and stable at ambient conditions.

### Polymer Template Fabrication

All presented micro- and nanostructures were TPP-printed from the POSS-glass resin in the Dip-In Laser Lithography (DiLL) configuration, where the resin was drop cast onto fused silica or silicon substrates and the printer's magnification objective was directly submerged into the material (74). After printing, the remaining uncured resin was dissolved in a 20 min-long isopropanol alcohol bath. The fabricated specimens were either dried in air, or, for the case of the most delicate structures, via supercritical drying to prevent damage from capillary forces. We used a Photonic Professional GT (Nanoscribe GmbH) system equipped with a Plan-Apochromat 63×1.4 Oil DIC M27 objective (Carl Zeiss AG) and a FemtoFiber pro NIR pulsed laser (TOPTICA Photonics AG) with a center wavelength of 780 nm, 80 MHz repetition rate and ˜100 fs pulse width. The laser average power was the mean power value at the aperture of the objective, with 100% output power corresponding to 50 mW. The transmittance of the objective was 65%.

TGA/DSC specimens were drop-cast from the POSS-glass resin and polymerized via 20 min single-photon flood exposure using an LQ-Box UV-lamp (Rolence Enterprise Inc.) with a peak wavelength of 405 nm and 150 mW/cm² average light intensity.

### Fused Silica Conversion

The printed hybrid organic-inorganic templates were converted to fused silica via thermal treatment in air atmosphere using a tube furnace. The applied heating profiles were comprised of a heating segment with a ramp rate of 1° C./min, followed by a 60 min hold at the maximum temperature and subsequent cooling to room temperature at 3° C./min. This protocol was found sufficient to accommodate for the degassing of volatilized species to prevent entrapment and cracking. The shrinkage of the structures was accommodated via appropriate print designs, such as compensating support structures (26, 30, 32).

### Materials Characterization

TGA, DSC and mass spectrometry data were simultaneously collected using a STA 449 F3 Jupiter® simultaneous thermal analyzer (Erich NETZSCH GmbH & Co. Holding KG), which was coupled with a QMS 403 Aeolos Quadro quadrupole mass spectrometer (Erich NETZSCH GmbH & Co. Holding KG) for evolved gas analysis. Experiments were conducted in either air, nitrogen, or oxygen atmosphere, as specified. Micro-Raman spectra were acquired from TPP-printed free-standing disk-shaped specimens (identical to UV-Vis-NIR specimens) with an inVia confocal Raman microscope (Renishaw plc). TEM measurements were conducted on a lamella extracted from the center plane of a 10 μm-diameter micro-pillar. The lamella was extracted using focused ion beam (FIB) milling with a FEI Quanta 3D FEG dual-beam SEM/FIB (Thermo Fisher Scientific Inc.). Bright field TEM micrographs were collected using a JEM-2100F TEM (JEOL Ltd.) operated at 200 kV. Select area diffraction was taken from the lamella interior with a 10-cm camera length. EELS was performed on a 300-kV JEM-ARM300F Grand ARM TEM (JEOL Ltd.) with spherical aberration correction and an Ultrascan 1000 CCD detector (Gatan Inc.) using an energy dispersion of 1.0 eV/channel. EELS quantification was performed in DigitalMicrograph (Gatan Inc.). Both O and Si K edges were quantified using a power-law background model, Hartree-Slater cross-section, and excluded the energy-loss near edge structure. The relative lamella thickness was less than 1 at each EELS spectra collection site.

### Optical Transmission, Surface Roughness, and Mechanical Characterization

Optical transmission measurements were collected from TPP-printed free-standing disk-shaped specimens using a 2030PV PRO™ UV-Visible-NIR Microspectrophotometer (CRAIC Technologies Inc.). AFM measurements were conducted with a Tosca 400AFM system (Anton Paar GmbH). The obtained roughness values correspond to the entire measured area. Mechanical experiments were performed at a constant strain rate of 0.01 sec-1 using an Alemnis Nanoindenter (Alemnis AG) equipped with a 100 μm-diameter flat punch diamond tip. Engineering stress and strain were determined from the measured load-displacement curves by applying the measured dimensions. A total of ten micro-pillars with an average diameter of 11.3±0.4 μm and a height-to-diameter aspect ratio of two have been tested.

### Optical Device Demonstration

The micro-lens shape was generated in Zemax OpticStudio v22.1 using the sequential solver. An aspherical profile was chosen and optimized to correct for spherical aberration, using a single wavelength (532 nm) under the assumption of collimated incident rays. The material properties of the fused silica were taken as equal to commercial Corning® 7980, which closely matched the properties determined by our materials characterization. The merit function optimized the spot size of the focused light based on RMS using Gaussian quadrature pupil integration with 4 rings, 21 rays in a dither pattern, and an entrance pupil diameter of 70 um. The aspheric radius (R), conic constant (κ), and the higher order aspheric coefficient (α_4) were allowed to vary during optimization. The design of the final micro-lenses was described by the relation between the sag height (z) and the radial coordinate (r), as given by

$$z ( r ) = \frac{{r}^{2}}{R ( 1 + \sqrt{1 - ( 1 + κ ) {( \frac{r}{R} )}^{2}} )} + {α}_{4} {r}^{4} \qquad Eq . ( 1 )$$

with R=−46.6, κ=−0.419, and α₄=1.9174e-06. Printed geometries were scaled up to account for a linear contraction of 42% during the conversion of the TPP-printed templates to the final fused silica glass. Optical profilometry measurements with the final POSS-glass micro-lenses were conducted with a MarSurf CM expert confocal microscope (Mahr GmbH) with a 320XS objective with a numerical aperture of 0.9 and 160×160 μm² field of view. The surface roughness was determined via the subtraction of a polynomial contour fit from the measured 3D topography. The obtained roughness values correspond to the entire measured area. Optical resolution measurements were conducted with a chrome TC-RT01 negative 1951 USAF-type resolution target (Technologie Manufaktur GmbH & Co. KG) under white light transmission illumination. Using 3-axis motion stages, the micro-lenses atop of a pin substrate were positioned above the resolution target. The images formed by the micro-lenses of the target, were projected onto a CMOS camera sensor with an optical microscope. The resolution was measured from the contrast intensity distribution across the imaged line patterns, with resolvability being determined by a clearly measurable contrast difference between the adjacent lines.

### Discussion on Mechanical Properties

The mechanical properties of TPP-printed POSS-glass structures were characterized after thermal treatment at 650° C. and 1000° C., each via five uniaxial compression experiments with 11 μm-diameter micro-pillars (FIG. 5D). After 650° C., the material showed elastic-plastic behavior with notable deformability, accommodating approximately 7% residual strain at failure. The yield strength was 2.0±0.1 GPa and the compressive strength reached 4.0±0.2 GPa. After treatment at 1000° C., the yield and compressive strength of the POSS-glass further increased to 3.1±0.3 GPa and 7±0.3 GPa, respectively, which well agrees with reported fused silica micropillars, prepared from bulk slip-cast sheets (63). However, the strength gain accompanied a more brittle response with a now mostly linear-elastic stress-strain curve. The behavior is consistent with observations in our micro-Raman data (FIG. 4D), which indicated structure rearrangement of some of the amorphous silica at higher temperatures and the removal of a trace amount of non-bridging oxygens.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### REFERENCES AND NOTES

1. F. Kotz et al., Nature. 544, 337-339 (2017).
2. F. Kotz et al., Adv. Mater., 2006341 (2021).
3. X. Wen et al., Nat. Mater. 20, 1506-1511 (2021).
4. M. Mader et al., Science. 372, 82-186 (2021).
5. H. Zappe, Fundamentals of micro-optics (Cambridge University Press, Cambridge, 2010; https://doi.org/10.1017/CBO9780511781797).
6. X. Q. Liu et al., Laser Photon. Rev. 13, 1800272 (2019).
7. D. M. Atkin, J. C. Knight, P. S. J. Russell, T. A. Birks, Opt. Lett. Vol. 21, Issue 19, pp. 1547-1549. 21, 1547-1549 (1996).
8. A. J. Ikushima, T. Fujiwara, K. Saito, J. Appl. Phys. 88, 1201 (2000).
9. A. S. Sinitskii, A. V. Knot'ko, Y. D. Tretyakov, Solid State Ionics. 172, 477-479 (2004).
10. M. C. Wu, O. Solgaard, J. E. Ford, J. Light. Technol. 24, 4433-4454 (2006).
11. T. Nagourney, S. Singh, B. Shiari, J. Y. Cho, K. Najafi, Proc. IEEE Int. Conf. Micro Electro Mech. Syst., 1000-1003 (2018).
12. D. Zhang, X. Liu, J. Qiu, 3D printing of glass by additive manufacturing techniques: a review. Front. Optoelectron. (2020), pp. 1-15.
13. P. Neužil, S. Giselbrecht, K. Länge, T. J. Huang, A. Manz, Nat. Rev. Drug Discov. 2012 118. 11, 620-632 (2012).
14. W. Menz, J. Mohr, O. Paul, Microsystem Technology (Wiley-VCH, Weinheim, 2001; https://onlinelibrary.wiley.com/doi/book/10.1002/9783527613007).
15. T. Baldacchini, Three-Dimensional Microfabrication Using Two-Photon Polymerization (Elsevier, Amsterdam, ed. 2nd, 2019).
16. M. Schmid, D. Ludescher, H. Giessen, Opt. Mater. Express. 9, 4564 (2019).
17. J. Bauer, A. Guell Izard, Y. Zhang, T. Baldacchini, L. Valdevit, Adv. Mater. Technol. 4, 1900146 (2019).
18. T. Gissibl, S. Thiele, A. Herkommer, H. Giessen, Nat. Photonics. 10, 554-560 (2016).
19. P.-I. Dietrich et al., Nat. Photonics 2018 124. 12, 241-247 (2018).
20. M. Blaicher et al., Light Sci. Appl. 2020 91. 9, 1-11 (2020).
21. F. Balli, M. Sultan, S. K. Lami, J. T. Hastings, Nat. Commun. 2020 111. 11, 1-8 (2020).
22. J. Wang, F. Sciarrino, A. Laing, M. G. Thompson, Nat. Photonics 2019 145. 14, 273-284 (2019).
23. G. von Freymann et al., Adv. Funct. Mater. 20, 1038-1052 (2010).
24. J. Fischer, T. Ergin, M. Wegener, Opt. Lett. 36, 2059-2061 (2011).
25. Z. Gan, Y. Cao, R. A. Evans, M. Gu, Nat. Commun. 2013 41. 4, 1-7 (2013).
26. J. Bauer, A. Schroer, R. Schwaiger, O. Kraft, Nat. Mater. 15, 438-443 (2016).
27. J. Bauer et al., Matter. 1, 1-10 (2019).
28. L. Brigo et al., Adv. Sci. 5, 1800937 (2018).
29. A. Vyatskikh, R. C. Ng, B. Edwards, R. M. Briggs, J. R. Greer, Nano Lett. 20, 3513-3520 (2020).
30. D. Gailevičius et al., Nanoscale Horizons. 4, 647-651 (2019).
31. Z. Hong et al., Opt. Vol. 8, Issue 6, pp. 904-910. 8, 904-910 (2021).
32. D. Gonzalez-Hernandez et al., Photonics. 8, 577 (2021).
33. Z. Hong, P. Ye, D. A. Loy, R. Liang, Adv. Sci. 9, 2105595 (2022).
34. S. W. Kuo, F. C. Chang, Prog. Polym. Sci. 36, 1649-1696 (2011).
35. J. J. Schwab, J. D. Lichtenhan, Appl. Organomet. Chem. 12, 707-713 (1998).
36. E. Tegou et al., Chem. Mater. 16, 2567-2577 (2004).
37. J. H. Moon, J. S. Seo, Y. Xu, S. Yang, J. Mater. Chem. 19, 4687-4691 (2009).
38. Y. Xu, X. Zhu, S. Yang, ACS Nano. 3, 3251-3259 (2009).
39. G. Fang, H. Cao, L. Cao, X. Duan, Adv. Mater. Technol. 3, 1700271 (2018).
40. H. F. Gruber, Prog. Polym. Sci. 17, 953-1044 (1992).
41. L. H. Nguyen, M. Straub, M. Gu, Adv. Funct. Mater. 15, 209-216 (2005).
42. T. Baldacchini et al., J. Appl. Phys. 95 (2004) (available at https://doi.org/10.1063/1.1728296).
43. C. Decker, Acta Polym. 45, 333-347 (1994).
44. G. Odian, Principles of Polymerization (John Wiley & Sons Inc., Hoboken, ed. 4th, 2004; www.copyright.com.).
45. C. Decker, Prog. Polym. Sci. 21, 593-650 (1996).
46. S. Maruo, J. T. Fourkas, Laser Photon. Rev. 2, 100-111 (2008).
47. Z. Czech, J. Kabatc, M. Bartkowiak, K. Mozelewska, D. Kwiatkowska, Polymers (Basel). 12, 2617 (2020).
48. J. T. Fourkas et al., Opt. Mater. Express, Vol. 9, Issue 6, pp. 2601-2616. 9, 2601-2616 (2019).
49. Z. Tomova, N. Liaros, S. A. Gutierrez Razo, S. M. Wolf, J. T. Fourkas, Laser Photon. Rev. 10, 849-854 (2016).
50. Q. Hu et al., Addit. Manuf. 51 (2022), doi:10.1016/J.ADDMA.2021.102575.
51.
52. M. Khorasaninejad et al., Science (80-.). 352, 1190-1194 (2016).
53. A. Goswami, G. Srivastava, A. M. Umarji, G. Madras, Thermochim. Acta. 547, 53-61 (2012).
54. L. Li, R. Liang, Y. Li, H. Liu, S. Feng, J. Colloid Interface Sci. 406, 30-36 (2013).
55. V. V. Krongauz, Thermochim. Acta. 503-504, 70-84 (2010).
56. K. Mishchik, thesis. Université Jean Monnet—Saint-Etienne (2012).
57. T. Baldacchini, M. Zimmerley, C.-H. Kuo, E. O. Potma, R. Zadoyan, J. Phys. Chem. B. 113, 12663-12668 (2009).
58. P. McMillan, Am. Mineral. 69, 622-644 (1984).
59. G. Bertoni, J. Verbeeck, Ultramicroscopy. 108, 782-790 (2008).
60. N. Miyajima et al., J. Microsc. 238, 200-209 (2010).
61. I. Cooperstein, E. Shukrun, O. Press, A. Kamyshny, S. Magdassi, ACS Appl. Mater. Interfaces. 10, 18879-18885 (2018).
62. D. G. Moore, L. Barbera, K. Masania, A. R. Studart, Nat. Mater. 19, 212-217 (2020).
63. R. N. Widmer et al., Mater. Des. 204, 109670 (2021).
64. A. Albiez, R. Schwaiger, MRS Adv. 4, 133-138 (2019).
65. J. Bauer, M. Sala-Casanovas, M. Amiri, L. Valdevit, Sci. Adv. 8, 3080 (2022).
66. S. Bruns, K. E. Johanns, H. U. R. Rehman, G. M. Pharr, K. Durst, J. Am. Ceram. Soc. 100, 1928-1940 (2017).
67. H. Ottevaere et al., J. Opt. A Pure Appl. Opt. 8, S407 (2006).
68. L. Siegle, S. Ristok, H. Giessen, Opt. Express, Vol. 31, Issue 3, pp. 4179-4189. 31, 4179-4189 (2023).
69. D. L. Gonzalez-Hernandez et al., Preprint (2021), doi:10.20944/PREPRINTS202111.0136.V1.
70. D. M. Rozelle, in Proc. 19th AAS/AIAA Space Flight Mechanics Meeting (2009), pp. 1157-1178.
71. S. M. Wiederhorn, J. Am. Ceram. Soc. 52, 99-105 (1969).
72. J. Bauer et al., Adv. Mater. 29, 1701850 (2017).
73. A. J. D. Shaikeea, H. Cui, M. O'Masta, X. R. Zheng, V. S. Deshpande, Nat. Mater. 2022, 1-8 (2022).

1. A method for fabricating glass structures on a substrate, the method comprising:
a) contacting the substrate with a liquid reactive composition comprising a silsesquioxane, acrylic oligomer or monomer, and a photoinitiator, the silsesquioxane and the acrylic oligomer or monomer each independently being functionalized with at least two acrylate groups;
b) directing light to the substrate such that the liquid reactive composition forms a polymeric structure on the substrate; and
c) thermally treating the polymeric structure in an oxygen-containing gas environment at a sufficiently high temperature to convert the polymeric structure to a glass structure, the sufficiently high temperature being lower than the melting point of the substrate.

2. The method of claim 1 wherein step b) is performed by two-photon polymerization printing.

3. The method of claim 1 wherein step b) through a linear (one-photon) photopolymerization step.

4. The method of claim 1 wherein step b) is performed by two step lithography or PIL.

5. The method of claim 1 wherein the sufficiently high temperature is from about 500° C. to about 800° C.

6. The method of claim 1 wherein the glass structure is a 3 dimensional nano-sized or micron-sized structure.

7. The method of claim 1 wherein the light can move relative to the substrate to form a patterned polymeric coating on the substrate that is converted to a patterned glass after being thermally treated.

8. The method of claim 1 wherein the silsesquioxane is described by [RSiO_{3/2}]ₙ, n is an even positive integer, R is H, C₁₋₆ alkyl, C₁₋₆ alkoxyl, or an acrylate-containing group with the proviso at least two of R₁, R₂, R₃, R₄, R₅, R₆, R₇, R. are an acrylate-containing group.

9. The method of claim 1 wherein the silsesquioxane is described by formula 1: 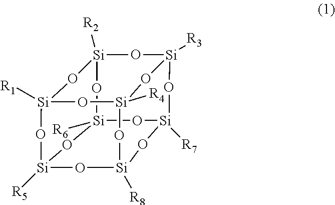
wherein R₁, R₂, R₃, R₄, R₅, R₆, R₇, R₈, are each independently H, C₁₋₆ alkyl, C₁₋₆ alkoxyl, or an acrylate-containing group with the proviso at least two of R₁, R₂, R₃, R₄, R₅, R₆, R₇, R₈ are an acrylate-containing group.

10. The method of claim 9 wherein each of R₁, R₂, R₃, R₄, R₅, R₆, R₇, R₈ are an acrylate-containing group.

11. The method of claim 1 wherein the silsesquioxane is described by formula 2, 3, or 4: 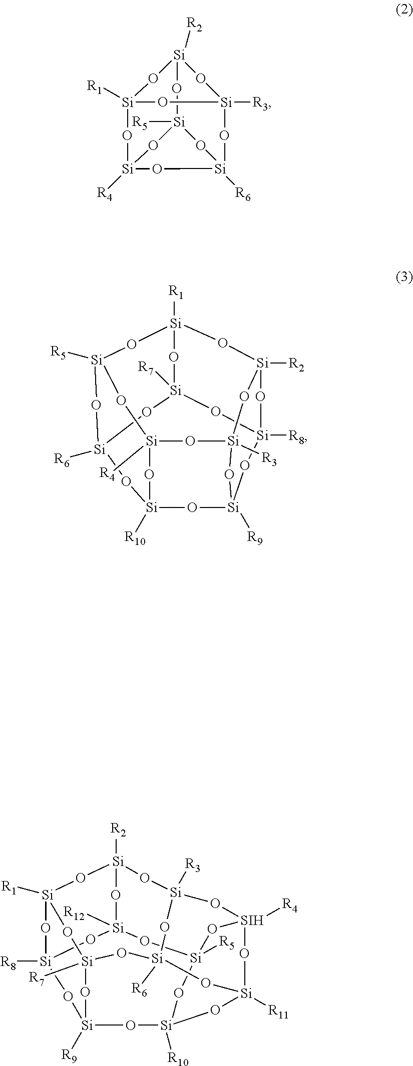
wherein R₁, R₂, R₃, R₄, R₅, R₆, R₇, R₈, R₉, R₁₀, R₁₁, R₁₂ are each independently H, C₁₋₆ alkyl, C₁₋₆ alkoxyl, or an acrylate-containing group with the proviso at least two of R₁, R₂, R₃, R₄, R₅, R₆, R₇, R₈, R₉, R₁₀, R₁₁, R₁₂ are an acrylate-containing group.

12. The method of claim 11 wherein each of R₁, R₂, R₃, R₄, R₅, R₆, R₇, R₈, R₉, R₁₀, R₁₁, R₁₂ are an acrylate-containing group.

13. The method of claim 8 wherein the acrylic oligomer or monomer is described by formula 5: 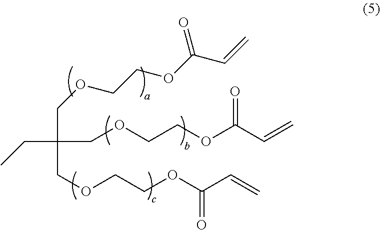
and a, b, c are each independently 1 to 6.

14. The method of claim 8 wherein the acrylic oligomer or monomer is described by formula 6: 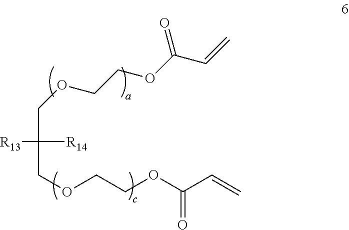
wherein R₁₃, R₁₄ are each independently H or C₁₋₆ alkyl and a, b, c are each independently 1 to 6.

15. The method of claim 8 wherein the acrylic oligomer or monomer is described by formula 6 or 7:

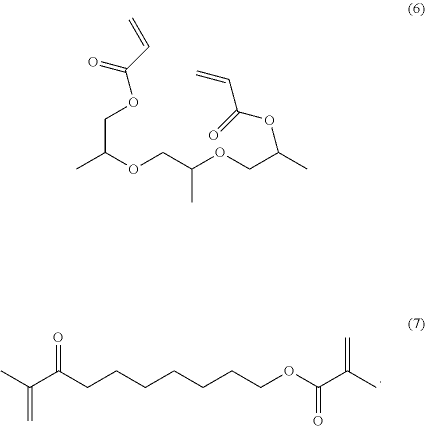

16. A method for fabricating glass structures on a substrate, the method comprising:
a) contacting the substrate with a liquid reactive composition comprising a silsesquioxane, acrylic oligomer or monomer, and a photoinitiator, the silsesquioxane and the acrylic oligomer or monomer each independently being functionalized with at least two acrylate groups;
b) applying two-photon polymerization 3D-printing to the liquid reactive composition such that the liquid reactive composition forms a polymeric structure on the substrate; and
c) thermally treating the polymeric structure in an oxygen-containing gas environment at a sufficiently high temperature to convert the polymeric structure to a glass structure, the sufficiently high temperature being lower than the melting point of the substrate.

17. The method of claim 16 wherein the sufficiently high temperature is from about 500° C. to about 800° C.

18. The method of claim 16 wherein the glass structure is a 3 dimensional nano-sized or micron-sized structure.

19. The method of claim 16 wherein the light can move relative to the substrate to form a patterned polymeric coating on the substrate that is converted to a patterned glass after being thermally treated.

20. The method of claim 16 wherein the silsesquioxane is described by [RSiO_{3/2}]ₙ, n is an even positive integer, R is H, C₁₋₆ alkyl, C₁₋₆ alkoxyl, or an acrylate-containing group with the proviso at least two of R₁, R₂, R₃, R₄, R₅, R₆, R₇, R₈ are an acrylate-containing group.

21. The method of claim 16 wherein the silsesquioxane is described by formula 1: 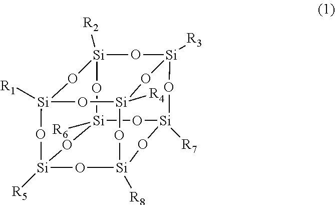
wherein R₁, R₂, R₃, R₄, R₅, R₆, R₇, R₈, are each independently H, C₁₋₆ alkyl, C₁₋₆ alkoxyl, or an acrylate-containing group with the proviso at least two of R₁, R₂, R₃, R₄, R₅, R₆, R₇, R₈ are an acrylate-containing group.

22. The method of claim 21 wherein each of R₁, R₂, R₃, R₄, R₅, R₆, R₇, R₈ are an acrylate-containing group.

23. The method of claim 16 wherein the silsesquioxane is described by formula 2, 3, or 4: 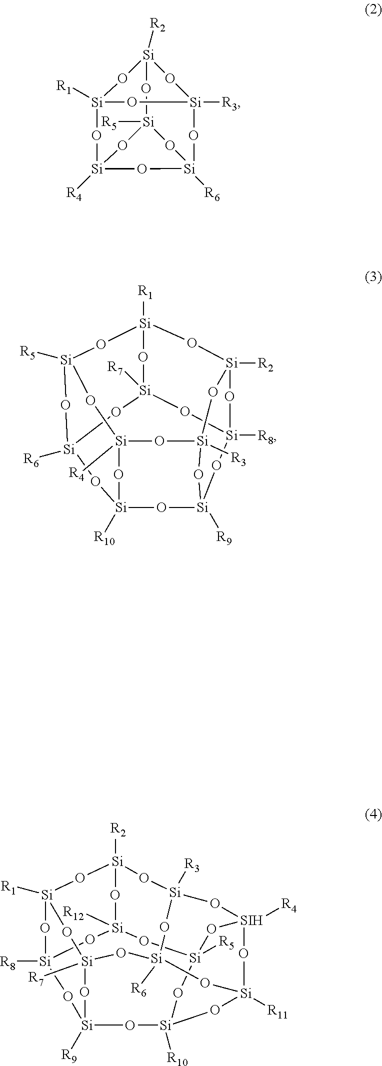
wherein R₁, R₂, R₃, R₄, R₅, R₆, R₇, R₈, R₉, R₁₀, R₁₁, R₁₂ are each independently H, C₁₋₆ alkyl, C₁₋₆ alkoxyl, or an acrylate-containing group with the proviso at least two of R₁, R₂, R₃, R₄, R₅, R₆, R₇, R₈, R₉, R₁₀, R₁₁, R₁₂ are an acrylate-containing group.

24. The method of claim 23 wherein each of R₁, R₂, R₃, R₄, R₅, R₆, R₇, R₈, R₉, R₁₀, R₁₁, R₁₂ are an acrylate-containing group.

25. The method of claim 23 wherein the acrylic oligomer or monomer is described by formula 5: 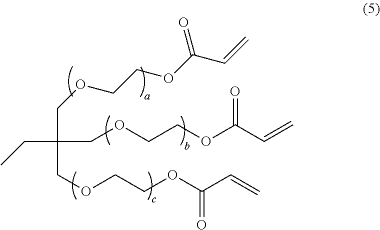
and a, b, c are each independently 1 to 6.

26. The method of claim 21 wherein the acrylic oligomer or monomer is described by formula 6: 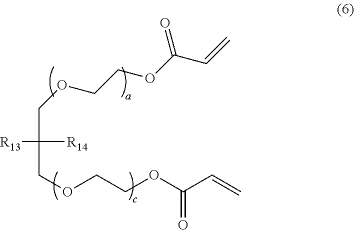
wherein R₁₃, R₁₄ are each independently H or C₁₋₆ alkyl and a, b, c are each independently 1 to 6.

27. The method of claim 21 wherein the acrylic oligomer or monomer is described by formula 6 or 7:

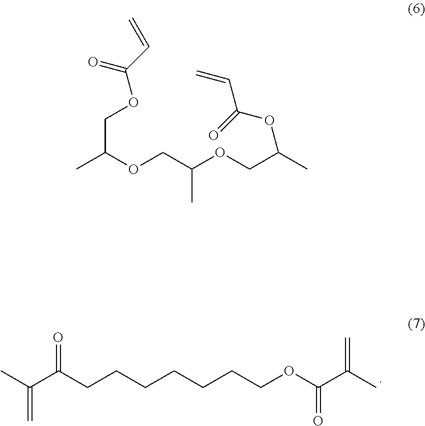

28. A method for fabricating ceramic structures on a substrate, the method comprising:
a) contacting the substrate with a liquid reactive composition comprising a silsesquioxane, acrylic oligomer or monomer, and a photoinitiator, the silsesquioxane and the acrylic oligomer or monomer each independently being functionalized with at least two acrylate groups;
b) directing light to the substrate such that the liquid reactive composition forms a polymeric structure on the substrate; and
c) thermally treating the polymeric structure in a vacuum or an inert gas-containing environment at a sufficiently high temperature to convert the polymeric structure to a carbon-containing structure, the sufficiently high temperature being lower than the melting point of the substrate.

29. A glass composition comprising:
a) residues of a silsesquioxane, acrylic oligomer or monomer, and a photoinitiator, the silsesquioxane and the acrylic oligomer or monomer each independently being functionalized with at least two acrylate groups; and
b) carbon in an amount of less than 1 weight percent of the total weight of the glass composition.

30. The glass composition of claim 29, having a 3 dimensional nano-sized or micron-sized structure.

31. The glass composition of claim 29, wherein the silsesquioxane is described by [RSiO_{3/2}]ₙ, n is an even positive integer, R is H, C₁₋₆ alkyl, C₁₋₆ alkoxyl, or an acrylate-containing group with the proviso at least two of R₁, R₂, R₃, R₄, R₅, R₆, R₇, R₈ are an acrylate-containing group.

32. The glass composition of claim 29, wherein the silsesquioxane is described by formula 1: 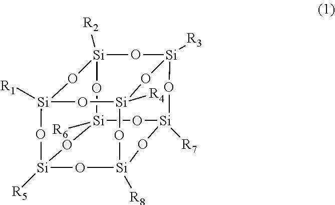
wherein R₁, R₂, R₃, R₄, R₅, R₆, R₇, R₈, are each independently H, C₁₋₆ alkyl, C₁₋₆ alkoxyl, or an acrylate-containing group with the proviso at least two of R₁, R₂, R₃, R₄, R₅, R₆, R₇, R₈ are an acrylate-containing group.

33. The glass composition of claim 32, wherein each of R₁, R₂, R₃, R₄, R₅, R₆, R₇, R₈ are an acrylate-containing group.

34. The glass composition of claim 29, wherein the silsesquioxane is described by formula 2, 3, or 4: 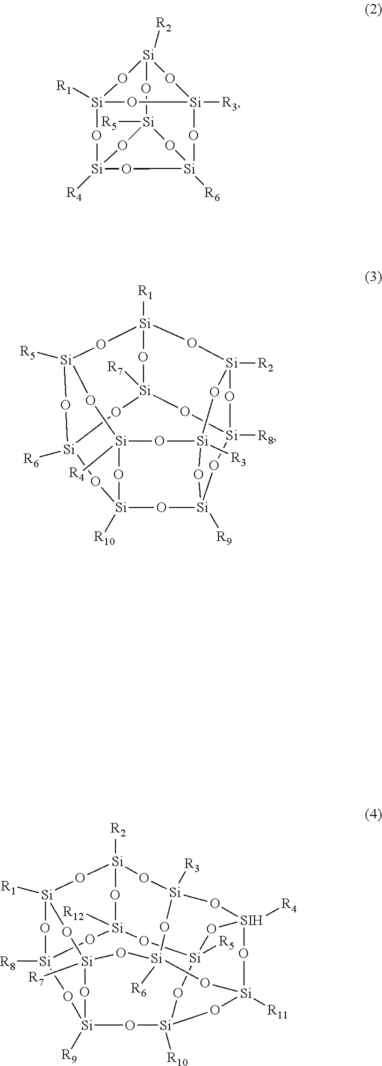
wherein R₁, R₂, R₃, R₄, R₅, R₆, R₇, R₈, R₉, R₁₀, R₁₁, R₁₂ are each independently H, C₁₋₆ alkyl, C₁₋₆ alkoxyl, or an acrylate-containing group with the proviso at least two of R₁, R₂, R₃, R₄, R₅, R₆, R₇, R₈, R₉, R₁₀, R₁₁, R₁₂ are an acrylate-containing group.

35. The glass composition of claim 34, wherein each of R₁, R₂, R₃, R₄, R₅, R₆, R₇, R₈, R₉, R₁₀, R₁₁, R₁₂ are an acrylate-containing group.

36. The glass composition of claim 34, wherein the acrylic oligomer or monomer is described by formula 5: 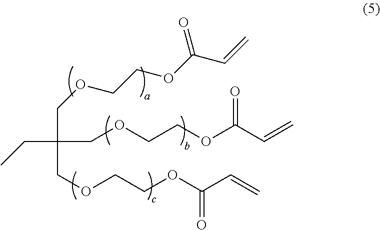
and a, b, c are each independently 1 to 6.

37. The glass composition of claim 29, wherein the acrylic oligomer or monomer is described by formula 5: 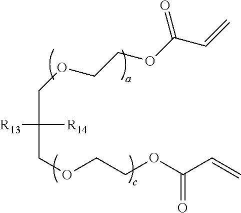
wherein R₁₃, R₁₄ are each independently H or C₁₋₆ alkyl and a, b, c are each independently 1 to 6.

38. The glass composition of claim 29, wherein the acrylic oligomer or monomer is described by formula 6 or 7:

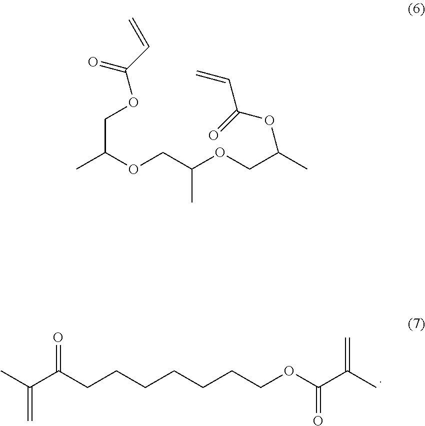

39. The glass composition of claim 29 including one or more nanostructures.

40. The glass composition of claim 39, wherein the nanostructures have at least one dimension from about 20 nm to 200 nm.

41. The glass composition of claim 39, wherein the nanostructures include rods having a spacing from about 50 to 500 nm.

42. The glass composition of claim 39, wherein the nanostructures include meso-scale micro-objectives.

43. The glass composition of claim 29 formed into a waveguide connecting two more photonic integrated circuits.

44. A lens system comprising the glass composition of claim 1.

45. The lens system of claim 44 including a single lens.

46. The lens system of claim 44 including two or more lens composed of the glass composition.

47. An endoscope including the lens system of claim 44 configured to focus light and a one or more image fibers.

48. The endoscope of claim 47, wherein the lens system positioned at a distal tip of the endoscope.

49. The endoscope of claim 47, wherein the lens system is directly deposited on the image fibers.

50. A diode laser system comprising a diode layer and the lens system of claim 44 configured to focus light.

51. The diode laser system of claim 50, wherein the lens system is directly deposited on the diode laser.

52. A micro-concentrators for solar cells including the lens system of claim 44.

53. A hemispherical resonator gyroscope including the glass composition of claim 29.
